(19) United States
(12) Patent Application Publication
(10) Pub. No.: US 2010/0030618 A1
(43) Pub. Date: Feb. 4, 2010

(54) System and method for visualizing a marketing strategy

(75) Inventors: Gregory A. Green, Sudbury, MA (US); Frank F. Davidson, Sherborn, MA (US); Ryder Daniels, Londonderry, NH (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Digitas, Inc., Boston, MA (US)

(21) Appl. No.: 12/221,211

(22) Filed: Jul. 31, 2008

(51) Int. Cl. G06F 17/00; G06F 3/048

(52) U.S. Cl. 705/10; 715/719; 700/90

(57) ABSTRACT

A system and method for visualizing a marketing strategy and its effects on a marketplace are disclosed. Using the system or method, an organization can visualize its marketing strategy in a way that links the original creative intent of the marketing strategy with the marketing strategy's effects upon a marketplace. The method and system enable the organization to evaluate the effectiveness of not only its marketing strategy, but of the creative process that led to the marketing strategy's development. The method and system employ representations of creative aspects of the marketing strategy and representations of effects of the marketing strategy on the marketplace, and present, via a graphical user interface, a user-interactive, creative-aspects-based structure, along with the representations of the effects of the marketing strategy, in a manner enabling interaction with the representations of the creative aspects and the effects on the marketplace.

### BACKGROUND OF THE INVENTION

Marketing involves communicating pertinent company and product related information to potential customers. To do so more effectively, organizations develop marketing strategies, which define the general approaches that the organizations plan to take to meet their objectives. These marketing strategies help the organizations allocate their resources to the marketing areas having the greatest potential to increase sales of their products or services.

Organizations develop marketing strategies to outline what the company intends to do to achieve its marketing objectives. In developing a marketing strategy, there are many decisions that must be made, for example, what information to communicate and to whom and how to communicate the information. Once these decisions are made, there are numerous tactics that may be implemented to employ the developed marketing strategy. Thus, a marketing strategy includes a well thought out series of marketing tactics to make the marketing strategy more effective. Marketing tactics are the various activities and tools that an organization may use to implement its marketing strategy, and they serve to bring the marketing strategy to life.

By way of example, one aspect of a marketing strategy for an example automotive manufacturing organization could be to switch used-car buyers from buying a used car to buying a new car. An example tactic for this strategy could include advertising a very inexpensive new car to the buyers of used cars. Once marketing strategies and tactics are put to practice, the strategies and tactics are generally tested for measurable results, such as statistics regarding the sales of a marketed product.

### SUMMARY OF THE INVENTION

An organization's marketing strategy may be very complex, employing many marketing tactics (i.e., implementations of the marketing strategy) and creative assets (e.g., television commercials or Internet banner advertisements). It is cumbersome to manage a large amount of such aspects of a marketing strategy, and even more so to track collected information regarding the performance of the marketing strategy (e.g., sales of a particular product during a particular timeframe, or amount of visibility of advertisements to consumers) and to determine how that performance information relates to the various aspects of the marketing strategy. A tool that enables such an organization to visualize its marketing strategy and to link the performance information with the original creative intent of the marketing strategy would be beneficial to the organization in evaluating the effectiveness of both its marketing strategy and the creative process from which it was developed.

One embodiment of the present invention is a system for enabling a user to visualize a marketing strategy and its effects on a marketplace. The system includes a linking module that enables representations of creative aspects of the marketing strategy to be linked together in a selectable manner, and an association module that is used to associate representations of the effects of the marketing strategy on the marketplace with the representations of the creative aspects. The system also includes a display module that presents, via a graphical user interface, at least a subset of the representations of the creative aspects in a user-interactive, creative-aspects-based structure along with the associated representations of the effects of the marketing strategy. The creative-aspects-based structure and the representations of the effects are displayed in a manner enabling the user to interact with the representations of the creative aspects and the effects to visualize the marketing strategy and its effects on the marketplace.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic diagram illustrating a system incorporating creative and analytical processes relating to a marketing strategy and displaying a visualization of the marketing strategy and its effects on a marketplace.

FIG. 2A is a flow diagram that illustrates visualizing a marketing strategy and its effects on a marketplace.

FIG. 2B is a block diagram illustrating a system for visualizing a marketing strategy and its effects on a marketplace.

FIG. 3 is a schematic diagram illustrating a system architecture for displaying a visualization of the marketing strategy and its effects on a marketplace.

FIG. 4 is a block diagram illustrating relationships between a marketing strategy, implementations of the marketing strategy, and creative assets of the marketing strategy.

FIG. 5 is a flow diagram that illustrates representing relationships between a marketing strategy, implementations of the marketing strategy, and creative assets of the marketing strategy.

FIG. 6 is a schematic diagram that illustrates representing and storing marketing information and associating the marketing information with a creative aspect of the marketing strategy.

FIG. 7 is a schematic diagram illustrating a system using stored representations of marketing information to incorporate the creative and analytical processes relating to a marketing strategy and display a visualization of the marketing strategy and its effects on a marketplace.

FIG. 8 is a flow diagram that illustrates representing and storing marketing information and associating the marketing information with the creative assets of the marketing strategy.

FIG. 9 is a schematic diagram illustrating a media software object that stores relationship information among a marketing strategy, implementation of the marketing strategy, creative asset, marketplace, marketing channel, and the marketing strategy's effect on the marketplace.

FIGS. 10A and 10B illustrate example extensible markup language (XML) code used to create a media software object.

FIG. 11 is a flow diagram that illustrates visualizing a marketing strategy and its effects on a marketplace using a media software object.

FIG. 12 is a hierarchical diagram illustrating a node-based hierarchy used to represent the relationship between a marketing strategy, implementations of the marketing strategy, and creative assets of the marketing strategy.

FIG. 13 is a block diagram illustrating a system for displaying a visualization of a marketing strategy and its effects on a marketplace, where the system includes a market effect module, collaboration module, comparison module, distribution module, reporting module, node selection module, navigation module, and integration module.

FIG. 14 is a schematic diagram illustrating a top-level view of a creative-aspects-based structure in the form of a node-based taxonomy.

FIG. 15 is a schematic diagram illustrating a top-level view of a creative-aspects-based structure in the form of a node-based taxonomy and displayed via a graphical user interface.

FIG. 16 is a flow diagram that illustrates a procedure for displaying portions of a node-based hierarchy (representing the relationship between a marketing strategy, implementations of the marketing strategy, and creative assets of the implementations) as a creative-aspects-based structure in the form of a node based taxonomy.

FIG. 17 is a screen view illustrating a lower-level view of a creative-aspects-based structure in the form of a node based taxonomy and displayed via a graphical user interface.

FIG. 18 is a screen view illustrating a lower-level view of a creative-aspects-based structure in the form of a node-based taxonomy, where the leaf nodes of the structure are displayed in multi-media formats.

FIGS. 19A-19C are screen views that illustrate a user's selecting a node of a displayed creative-aspects-based structure and changing the central focus to the selected node.

FIG. 20 is a flow diagram that illustrates selecting a node of a displayed creative-aspects-based structure and changing the central focus to the selected node.

FIG. 21 is a screen view illustrating a dynamic page interface for displaying a plurality of creative assets in multi-media formats.

FIG. 22 is a screen view illustrating a linearly-flowing interface for displaying a plurality of creative assets in multi-media formats.

FIG. 23 is a flow diagram that illustrates displaying a plurality of creative assets in different screen views.

FIG. 24 is a screen view that illustrates a user's selecting a creative asset of a displayed creative-aspects-based structure and temporarily storing a media software object associated with the creative asset to be applied to another environment.

FIG. 25 is a flow diagram that supports a user's selecting a creative asset of a displayed creative-aspects-based structure, temporarily storing a media software object associated with the creative asset, and taking further action with the creative asset.

FIG. 26 is a network diagram that illustrates providing a creative asset to a plurality of entities for feedback regarding potential performance of the creative asset and obtaining a score for the creative asset.

FIG. 27 is a screen view illustrating an example graphical user interface including a collaboration tool for providing a creative asset to a plurality of entities for feedback.

FIGS. 28A-28C are screen views illustrating example interfaces for providing a creative asset to a collaboration tool for the purpose of receiving feedback from a plurality of entities.

FIG. 29 is a screen view illustrating an example interface for providing feedback regarding a creative asset provided by another entity.

FIG. 30 is a flow diagram that illustrates providing a creative asset to a plurality of entities for feedback regarding potential performance of the creative asset and obtaining a score for the creative asset.

FIG. 31 is a flow diagram that illustrates specifying further detailed information when providing a creative asset to a plurality of entities for feedback regarding potential performance of the creative asset.

FIG. 32 is a screen view illustrating an output of a distribution module that sorts and presents creative assets distributed in a two-dimensional grid.

FIG. 33 is a flow diagram that illustrates sorting and presenting creative assets distributed in a two-dimensional grid, and optionally determining and reporting marketing areas that are potentially underdeveloped based in the distribution.

FIG. 34 is a flow diagram that illustrates recording a user's sequence of navigation through a creative-aspects-based structure and presenting, at a later time, a series of views of the creative-aspects-based structure that represent the user's sequence of navigation.

### DETAILED DESCRIPTION OF THE INVENTION

A description of example embodiments of the invention follows.

Embodiments of the present invention enable an organization to visualize its marketing strategy along with the marketing strategy's effects on a marketplace. The visualization enables the organization to view the relationship between the creative process that led to the development of the marketing strategy (with all of its creative aspects) and the analytic process of determining the marketing strategy's effects on the marketplace (i.e., determination of how a marketing strategy has performed). The following definitions may be helpful in explaining the embodiments of the present invention.

Marketing Strategy: An organization's plan for marketing a product or service, including development, promotion, distribution, and pricing of the product or service. The marketing strategy may identify the organization's overall marketing goals and may explain how the goals will be achieved within a given timeframe. A marketing strategy is usually part of an organization's overall corporate plan.

Marketing Tactic: An implementation of a marketing strategy, that is, an activity in conformance with or in furtherance of the marketing strategy. Marketing tactics bring the marketing strategy to life and attempt to create a connection between an organization and a potential consumer of the organization's products or services.

Creative Asset: A tangible, or perceptible, item that is created for and used in implementing a marketing strategy. Creative assets may include such items as television commercials, radio broadcasts, Internet banner advertisements, flyers, and billboards.

Creative Aspect of a Marketing Strategy: Any aspect of a marketing strategy that results from the creative process used to develop the marketing strategy. Creative aspects may include creative assets (e.g., television advertisement for a new car), marketing tactics (e.g., advertising a very inexpensive new car to buyers of used cars), and even a feeling that the marketing strategy is intended to give consumers (e.g., nostalgia).

Visualization of a Marketing Strategy: A graphical or pictorial representation of a marketing strategy, including the various creative aspects that make up the marketing strategy. Such a visualization enables one to view a creative asset in the context for which is was created, and provides a richer, more meaningful overview of the marketing strategy.

Marketplace: The commercial world, that is, the realm of business, trade, and economics. The term marketplace is often used to refer to a place where ideas, thoughts, and artistic creations, compete for recognition.

Effects on a Marketplace: Measurable, or perceptible, effects that a marketing strategy, or portion thereof, has on a marketplace, including effects on consumers or brands. Such measurable or perceptible effects may include performance data regarding the marketing strategy (e.g., the number of clicks on a particular Internet advertisement or an increase in the number of sales caused by the marketing strategy) and increased brand recognition. The effects may be measured with respect to the entire marketing strategy, or with respect to one or more particular aspects of the marketing strategy.

Marketing Channel: A medium by which a creative asset is communicated, or presented, to potential consumers. Examples of marketing channels include television, radio, the Internet, and magazines.

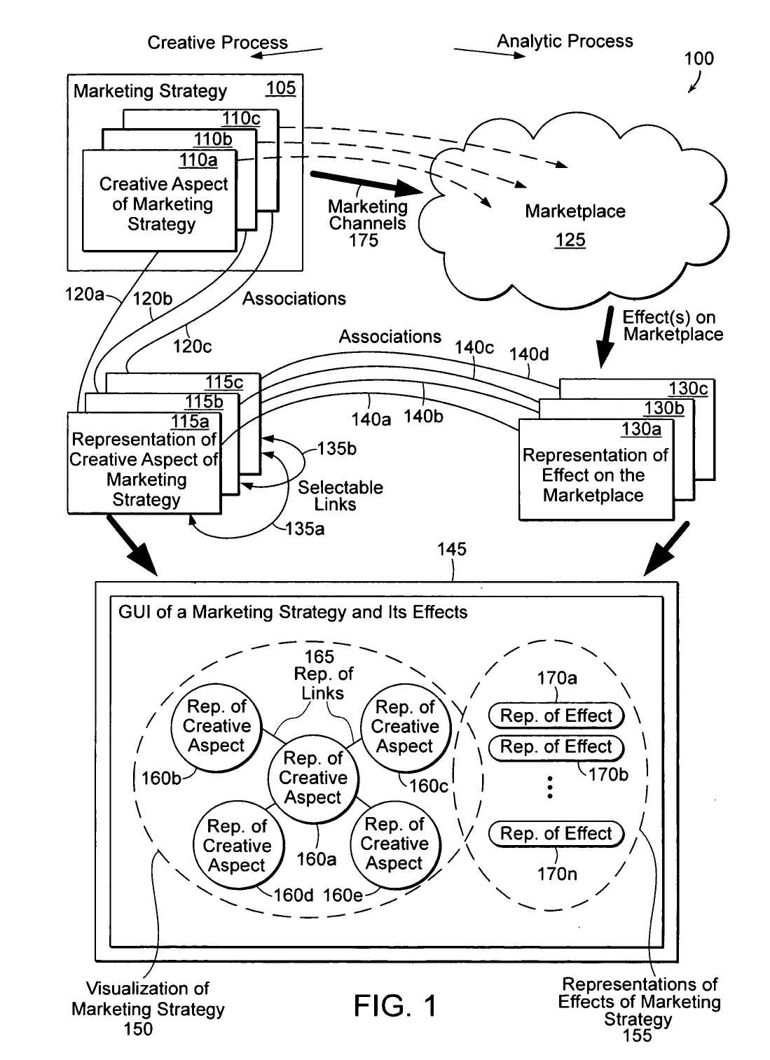

FIG. 1 is a schematic diagram illustrating a system 100 incorporating creative and analytical processes relating to a marketing strategy 105 and displaying a visualization of the marketing strategy 150 and its effects on a marketplace 155, according to an embodiment of the present invention.

As presented above, embodiments provide a visualization of the relationship between the creative and analytic processes of a marketing strategy 105. The creative process involves the development of a marketing strategy 105, including all of the creative aspects 110a-c that make up the marketing strategy 105 (e.g., advertisements for a particular product, as well as through what marketing channels 175 to communicate those advertisements). After the marketing strategy 105 is developed, it is put to practice in a particular marketplace 125 by developing creative assets (certain aspects 110a-c of the marketing strategy 105) and executing marketing tactics. Creative assets are typically presented to potential consumers through various marketing channels 175 (e.g., television, radio, the Internet, and magazines). Once put to practice, the marketing strategy 105 has certain effects (not shown) on the marketplace 125 (e.g., number of views by consumers of a particular advertisement). These effects are not only attributable to the marketing strategy 105 as a whole, but also to various combinations of the aspects 110a-c that make up the marketing strategy 105. Many types of effects may be measured, such as the number of sales of a product or number of clicks on Internet advertisements, and may be associated with the creative aspects 110a-c that led to the effects.

According to the example embodiment illustrated in FIG. 1, representations 115a-c of the creative aspects 110a-c of the marketing strategy 105 are created and linked together in a selectable manner. The links 135a, 135b between the representations 115a-c are selected in such a way as to represent the relationship between or among the various creative aspects 110a-c. For example, one creative aspect 110a may be the idea of trafficking (i.e., securing a means for communicating and then communicating) an advertisement via an Internet marketing channel, and other creative aspects 110b, 110c may be particular Internet banner advertisements. Each of the representations of the Internet banner advertisements are likely selected to be linked, either directly or indirectly, to a representation of the Internet marketing channel. Such links represent that the Internet banner advertisements are communicated to potential consumers via the Internet marketing channel.

Representations of the effects 130a-c on the marketplace 125 are also created and associated 140a-d with the representations 115a-c of the creative aspects 110a-c of the marketing strategy 105. The representations of the effects 130a-c may be associated with the representations 115a-c of the creative aspects 110a-c in a manner representing the relationship of the effects with the creative aspects 110a-c of the marketing strategy 105. For example, it may be known that a particular Internet banner advertisement for a product caused a certain number of “click-throughs” by consumers, which then resulted in a certain additional number of sales of the product. The number of click-throughs or additional sales (i.e., effects on the marketplace) may then be associated with the particular Internet banner advertisement (i.e., creative aspect) that caused the click-throughs or increased sales.

After the associations 140a-d are made, the example embodiment can then present a visualization of the marketing strategy 150 along with the associated effects of the marketing strategy on the marketplace 155. The visualization is presented in a graphical user interface 145 and includes a user-interactive, creative-aspects-based structure 160a-e, which is defined herein to be a graphical or pictorial structure that represents at least a portion of the creative aspects 110a-c of a marketing strategy 105 and the relationships 135a, 135b between or among those creative aspects 110a-c. In one embodiment, the structure may take a form of, for example, a graph that includes vertices 160a-e and edges 165 connecting the vertices 160a-e, where the vertices 160a-e represent the various creative aspects 110a-c and the edges 165 represent the relationships 135a, 135b between the creative aspects 110a-c. In another embodiment, the structure may take on a form of, for example, graphical elements 160a-e interconnected by representations of links 165 that remain connected to the graphical elements 160a-e even as a user manipulates the graphical elements 160a-e about a screen view 145.

Also presented via the graphical user interface 145 are the representations of the effects 155 of the marketing strategy 105. A user viewing the visualization can interact with the representations of the creative aspects 150 and the representations of the effects 155. Such interaction may include selection of one or more of the elements of the creative-aspects-based structure 160a-e, which causes representations of the effect data associated with those selected elements to be presented to the user. In this versatile manner, the user can meaningfully visualize the marketing strategy and its effects on the marketplace.

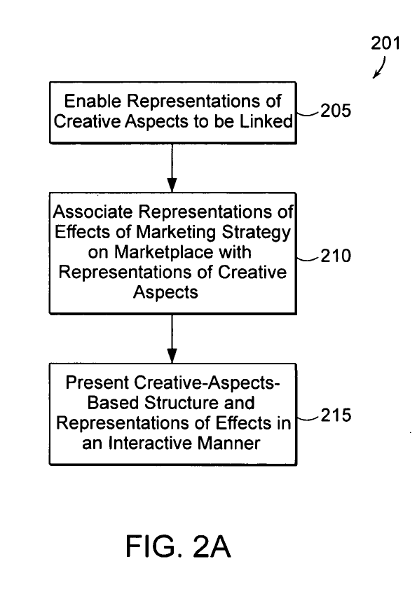

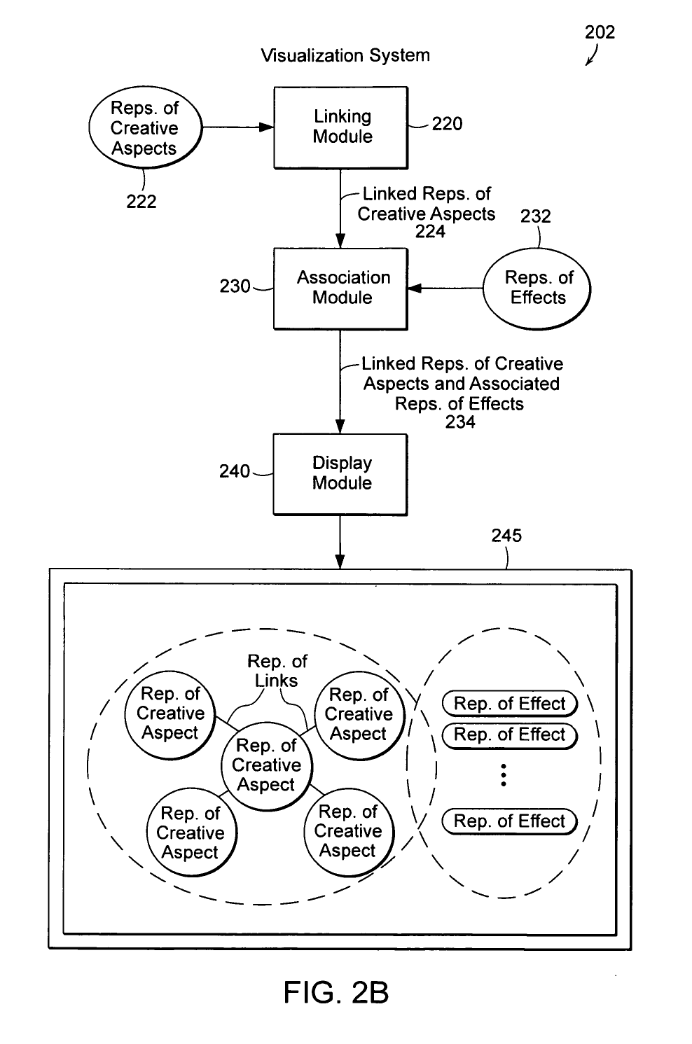

FIG. 2A is a flow diagram 201 that illustrates visualizing a marketing strategy and its effects on a marketplace. According to the example embodiment, representations of creative aspects of the marketing strategy are enabled to be linked together in a selectable manner (205). Representations of the effects of the marketing strategy on the marketplace are then associated with the representations of the creative aspects (210). Once the associations have been made, the embodiment presents a user-interactive, creative-aspects-based structure in a graphical user interface, along with the representations of the effects of the marketing strategy (215). The representations are presented in an interactive manner; thus, enabling a user of the embodiment to interact with the representations to visualize the marketing strategy and its effects on the marketplace.

FIG. 2B is a block diagram illustrating a system 202 for visualizing a marketing strategy and its effects on a marketplace, according to an embodiment of the present invention. The embodiment 202 includes a linking module 220 that enables representations of creative aspects 222 of the marketing strategy to be linked together in a selectable manner, resulting in linked representations of creative aspects 224, and an association module 230 that is used to associate representations of the effects 232 of the marketing strategy on the marketplace with the representations of the creative aspects 222, resulting in linked representations of creative aspects and associated representations of effects 234. A display module 240 then presents, via a graphical user interface 245, representations of the creative aspects in a user-interactive, creative-aspects-based structure, as well as the representations of the effects of the marketing strategy. The display module 240 presents the representations in a manner enabling the user to interact with the representations of the creative aspects and the representations of the effects to visualize the marketing strategy and its effects on the marketplace.

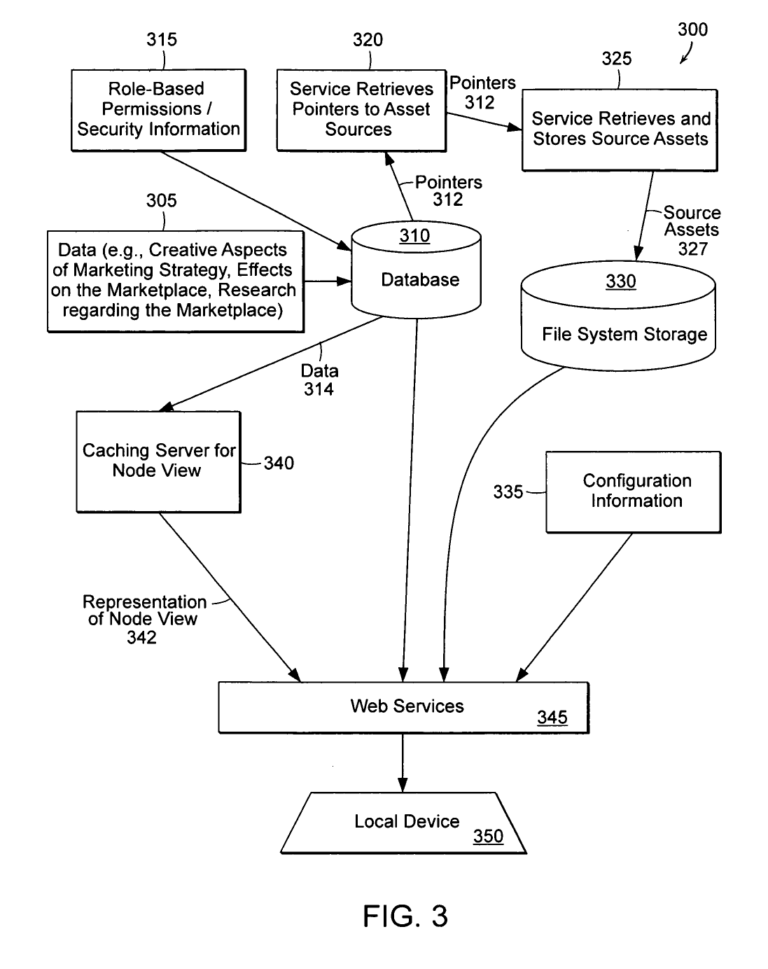

FIG. 3 is a schematic diagram illustrating a system architecture 300 for displaying a visualization of the marketing strategy and its effects on a marketplace, according to an embodiment of the present invention. Data 305 representing the creative aspects of the marketing strategy, representations of the strategy's effects on the marketplace, and other related information, such as research about the marketplace, is provided to a database 310, which may utilize any commercial or custom database program (e.g., Microsoft® or PostgresSQL™). The data may be known internally within an organization, or may obtained from external sources, such as Doubleclick® and Nielsen®. Before being entered into the database 310, the data 305 may undergo Extract, Transform, and Load (ETL) processing to put the data 305 in a format capable of being handled by the database 310. The data may also undergo other processing, such as algorithms and computations involving, for example, time regression analysis. Such processing may be performed by various components of the system architecture 300, such as the database 310, the web services 345, or the local device 350.

Many entries in the database 310 may be pointers, e.g., Uniform Resource Locators (URLs), to other data, such as in the case of creative assets, which are typically represented in large files. In such cases, a service 320 may retrieve the pointers 312 to such assets and another, or the same, service 325 may retrieve the assets to which the pointers 312 point. According to the example embodiment, the retrieved assets 327 are stored in a file system storage 330, rather than the database 310. The file system storage 330 may be implemented using Windows® Sharepoint®, or other centralized repository for shared documents, under an Internet information server, allowing the system to access the assets using pointer references, such as URLs.

The data stored in the database 310 and the file system storage 330 is provided to a web service 345, which resides on a web server (not shown). In providing the data 314 from the database 310 to the web service 345, the example embodiment utilizes a caching server 340 to preprocess information that a user of the system is likely to request, enabling the system to function more quickly. Such cached information may include information necessary for rendering the creative-aspects-based structure, which, as is presented in more detail below, may be a node-based structure. This rendering information may be sent to the web service 345 in an extensible markup language (XML) format.

The example embodiment may also utilize role-based permissions 315 and configuration information 335 for security and customization purposes for each user of the system. The configuration information 335 may be provided in an XML format and may serve to configure, for example, menus, views, web service locations, and icons. Information generated by the web service 345 is then sent to a local device 350 for presentation to the user. Again, the information sent to the local device 350 may be provided in an XML format. Many embodiments utilize an application to display the information to the user, as opposed to a web page. If the user access the system via a web page, the information displayed by the application is delivered to the user via the web page.

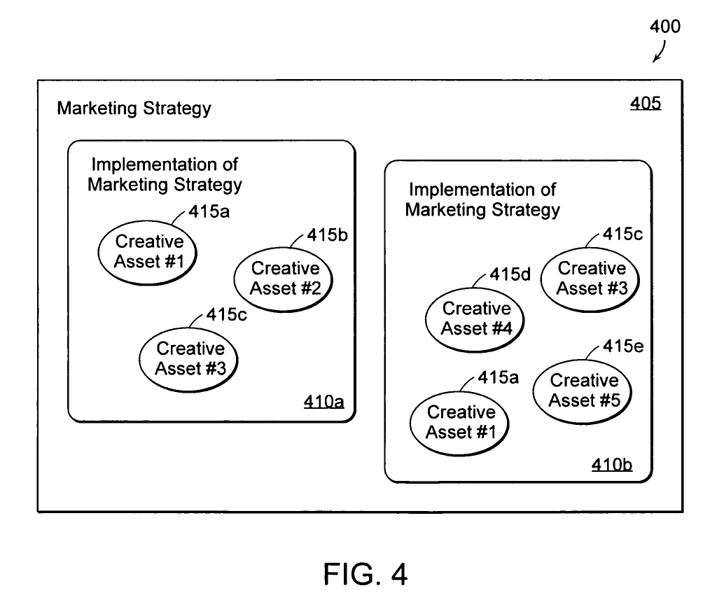

FIG. 4 is a block diagram 400 illustrating relationships between a marketing strategy 405, implementations of the marketing strategy 410a, 410b, and creative assets 415a-e of the marketing strategy 405. As illustrated in FIG. 4, a marketing strategy 405 may encompass multiple implementations of the marketing strategy 410a, 410b (i.e., marketing tactics). Each implementation 410a, 410b can include multiple creative assets 415a-e used in the implementation 410a, 410b. It should be noted that the multiple implementations 410a, 410b may share all or a subset of the creative assets 415a-e, for example, creative assets 415a and 415c are shared by both implementations 410a and 410b.

As presented in the above example, a marketing strategy for selling new cars could include switching used-car buyers from buying a used car to buying a new car. An example implementation for this strategy can include advertising a very inexpensive new car to the buyers of used cars via a web site about used cars. A creative asset used by this implementation can be an Internet banner advertisement for an inexpensive new car that is placed on the web site.

It should be understood that each of these elements 405, 410a, 410b, and 415a-e are creative aspects of a marketing strategy. According to an example embodiment, and with reference to both FIGS. 1 and 4, one of the creative aspects of the marketing strategy 110a-c (FIG. 1) may be the marketing strategy 405 itself; thus, a corresponding representation 115a-c (FIG. 1) of the creative aspect 110a-c (FIG. 1) may be a representation of the marketing strategy 405. Similarly, another one of the creative aspects of the marketing strategy 110a-c (FIG. 1) may be an implementation 410a, 410b of the marketing strategy and, thus, a corresponding representation 115a-c (FIG. 1) of the creative aspect 110a-c (FIG. 1) may be a representation of the implementation 410a, 410b. Because an implementation of a marketing strategy is related to the overall marketing strategy, the representation of the implementation of the marketing strategy is associated with the representation of the marketing strategy.

Similarly, yet another of the creative aspects 110a-c (FIG. 1) may be a creative asset 415a-e of the marketing strategy and, thus, a corresponding representation 115a-c (FIG. 1) of the creative aspect 110a-c (FIG. 1) may be a representation of the creative asset 415a-e. Because a creative asset of a marketing strategy is related to an implementation of the marketing strategy, the representation of the creative asset is associated with the related representation of the implementation of the marketing strategy.

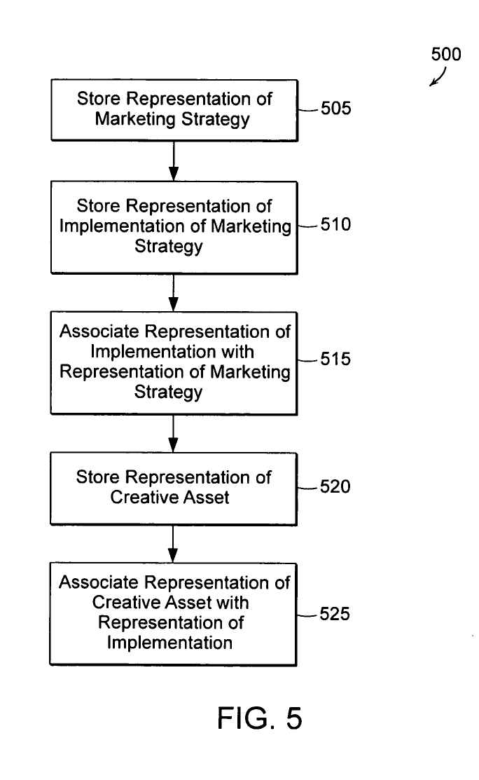

FIG. 5 is a flow diagram 500 that illustrates representing relationships between a marketing strategy, implementations of the marketing strategy, and creative assets of the marketing strategy, according to an embodiment of the present invention. To represent such relationships, the example embodiment stores a representation of the marketing strategy (505), stores a representation of an implementation of the marketing strategy (510), and associates the representation of the implementation with the representation of the marketing strategy (515). The example embodiment also stores a representation of a creative asset of the marketing strategy (520), and associates the representation of the creative asset with the representation of the implementation of the marketing strategy (525). As presented above, the marketing strategy, implementation of the marketing strategy, and creative asset are all creative aspects of the marketing strategy.

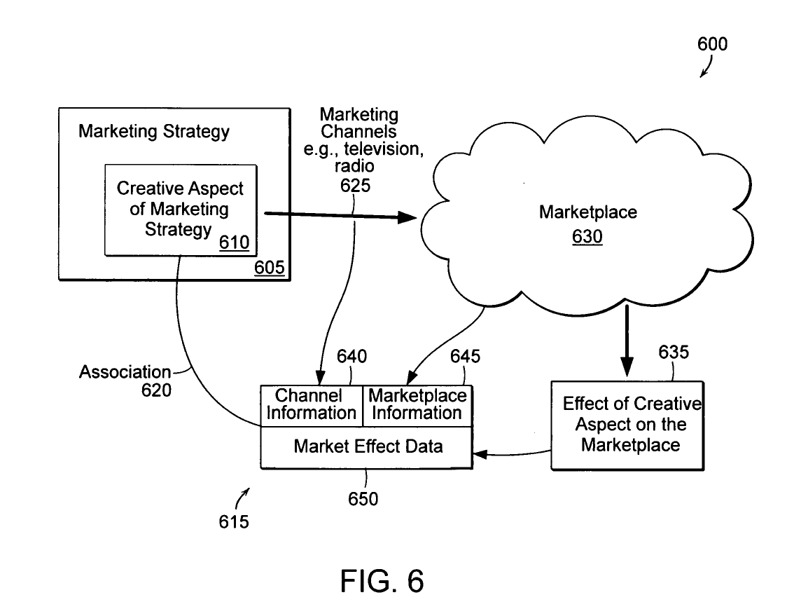

FIG. 6 is a schematic diagram 600 that illustrates representing and storing marketing information 615 and associating the marketing information 615 with a creative aspect 610 of the marketing strategy, according to an embodiment of the present invention. As illustrated in FIG. 6, a creative aspect 610 of the marketing strategy 605 (such as a creative asset) is presented to a potential consumer in the marketplace 630 via at least one marketing channel 625. The marketing channel may include any type of medium used in the field of marketing, such as television, radio, the Internet, and magazines. After the creative asset 610 has been presented in the marketplace 630 via the marketing channel 625, an effect that the creative asset had on the marketplace 635 may be obtained.

Once the effect of the creative asset is determined, a market effect module (not shown) may store marketing information 640, 645 representing both the marketplace 630, which includes a plurality of marketing channels 625, and trafficking of the creative asset 610 via at least one of the marketing channels 625. The market effect module also stores market effect data 650 that reflects the effect 635 that the creative asset had on the marketplace 630. After storing this information 615, the market effect module associates the channel and marketplace information 640, 645 and the market effect data 650 with the representation (not shown) of the creative asset 610.

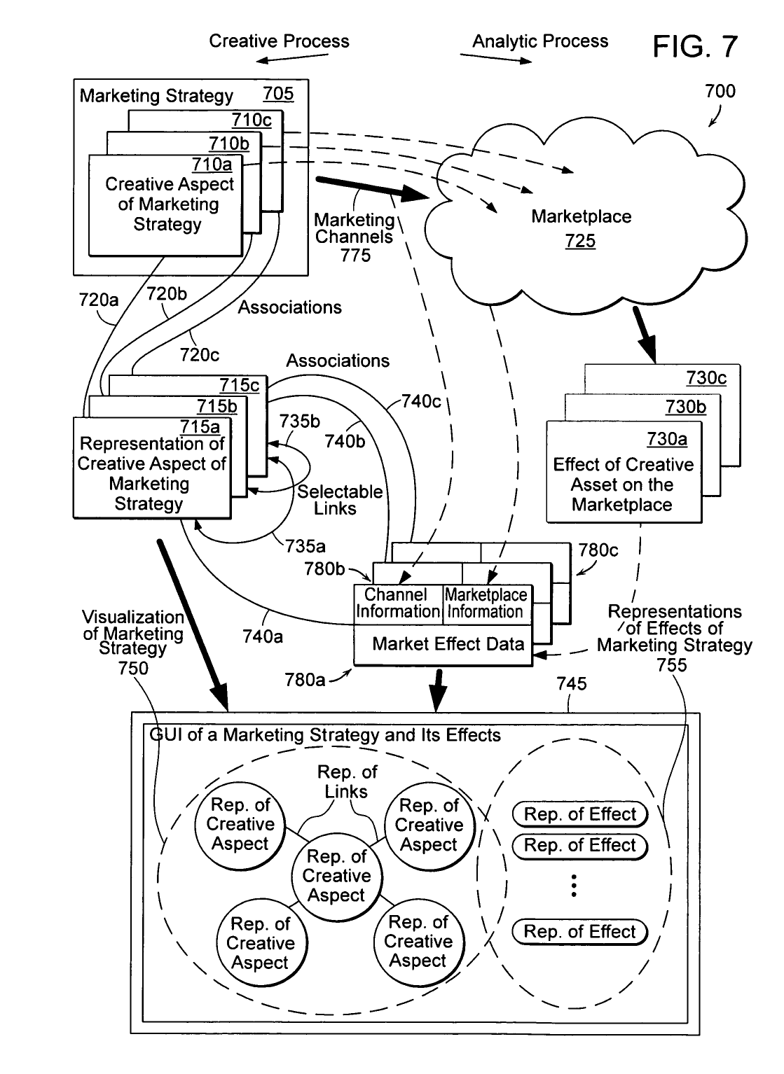

FIG. 7 is a schematic diagram illustrating a system 700 using stored representations of marketing information and market effect data 780a-c to incorporate the creative and analytical processes relating to a marketing strategy 705 and display a visualization of the marketing strategy 750 and its effects on a marketplace 755, according to an embodiment of the present invention. As in the example embodiment of FIG. 1, representations 715a-c of creative aspects 710a-c of the marketing strategy 705 are created. Representations of the effects 730a-c on the marketplace 725 are also created, but are associated 740a-c with the representations 715a-c of the creative aspects 710a-c using the marketing information and market effect data 780a-c generated by a market effect module (not shown), as presented above. After the representations 715a-c of the creative aspects 710a-c are associated with the marketing information and market effect data 780a-c, the example embodiment can then present a visualization of the marketing strategy 750 along with the associated effects of the marketing strategy on the marketplace 755, much like as in the embodiment of FIG. 1.

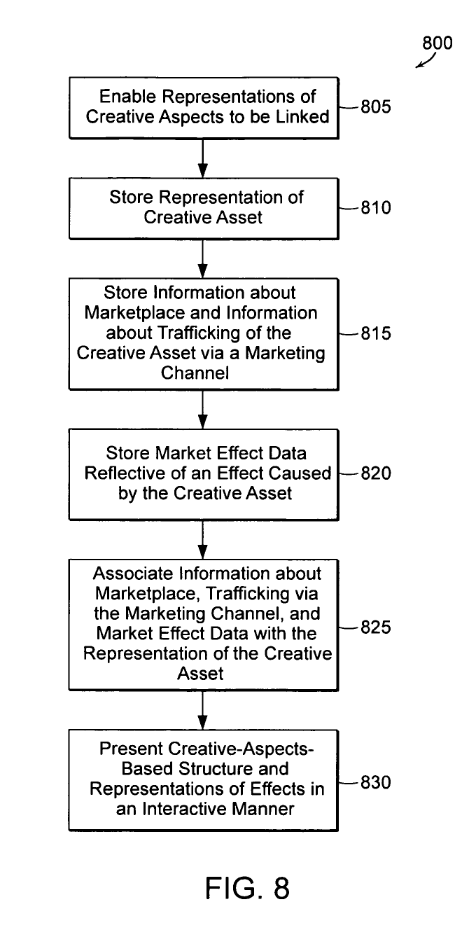

FIG. 8 is a flow diagram 800 that illustrates representing and storing marketing information and associating the marketing information with the creative assets of the marketing strategy, according to an embodiment of the present invention. As in the embodiment of FIG. 2A, representations of creative aspects of the marketing strategy are enabled to be linked together in a selectable manner (805). The embodiment then stores a representation of a creative asset (810) and stores marketing information, which represents the marketplace and trafficking of the creative asset via a marketing channel of the marketplace (815). Market effect data that reflects an effect on the marketplace caused by the creative asset is also stored (820). Once this information is stored, the embodiment associates the information representing the marketplace, trafficking of the creative asset via a marketing channel, and market effect data with the representation of a creative asset (825). As in the embodiment of FIG. 2A, a user-interactive, creative-aspects-based structure is then displayed in a graphical user interface, along with the representations of the effects of the marketing strategy (830).

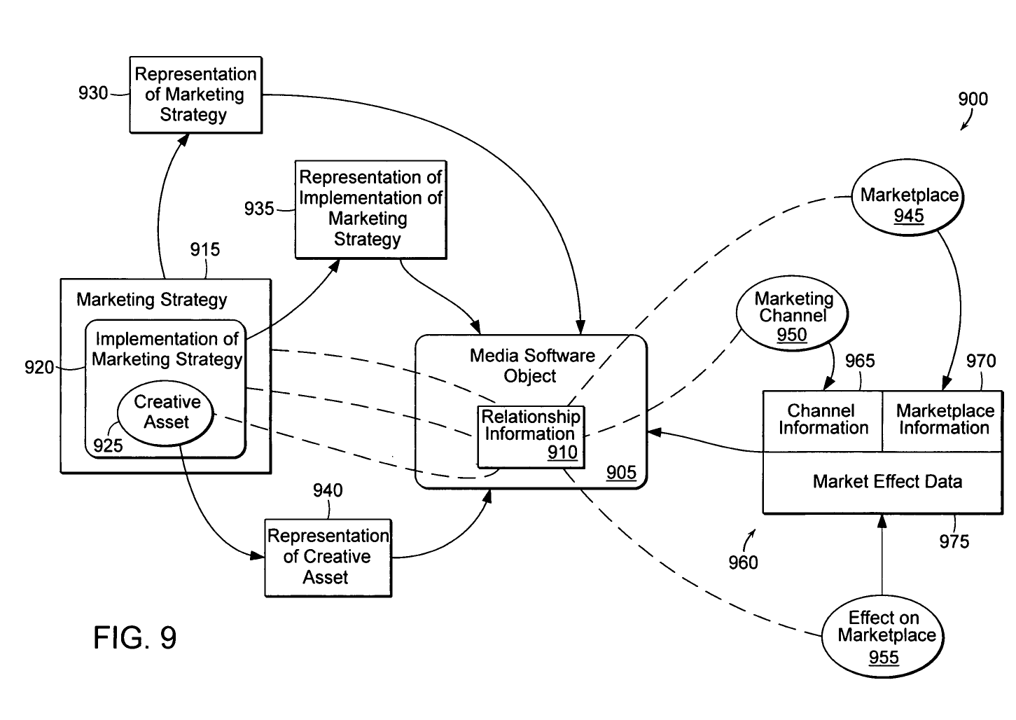

FIG. 9 is a schematic diagram 900 illustrating a media software object 905 that stores relationship information 910 among a marketing strategy 915, implementation of the marketing strategy 920, creative asset 925, marketplace 945, marketing channel 950, and the marketing strategy's effect on the marketplace 955, according to an embodiment of the present invention. A media software object is data structure that stores the relationship information among the above elements, and optionally other elements (not shown) in other embodiments. The media software object 905 is created by consolidating a representation of the marketing strategy 930, representation of the implementation of the marketing strategy 935, representation of the creative asset 940, marketing information 965, 970, and market effect data 975. Each of these representations, information, and data is presented above. The relationships among the marketing strategy 915, implementation of the marketing strategy 920, creative asset 925, marketplace 945, marketing channel 950, and effect on the marketplace 955 are then stored in the media software object data structure 905.

Examples of relationship information 910 include information indicating that a particular creative asset 925 is part of a particular implementation of the marketing strategy 920. It may also include information indicating that the creative asset 925 was presented in the marketplace 945 via a particular marketing channel 950, and information indicating the measured effect that the creative asset 925 had on the marketplace 955. For example, in the above example marketing strategy for switching used-car buyers from buying a used car to buying a new car, the relationship information 910 may indicate that a particular Internet banner advertisement for an inexpensive new car is part of a tactic of advertising a very inexpensive new car to the buyers of used cars via a web site about used cars. The relationship information 910 may also indicate that the Internet banner advertisement was presented in the marketplace via the Internet marketing channel, and that the particular advertisement caused a certain number of additional sales of the new car.

Once created, the media software object 905 is associated with a particular creative asset 925, and the embodiment employs the relationship information 910 of the media software object 905 when presenting the user-interactive, creative-aspects-based structure, and the representations of the effects of the marketing strategy.

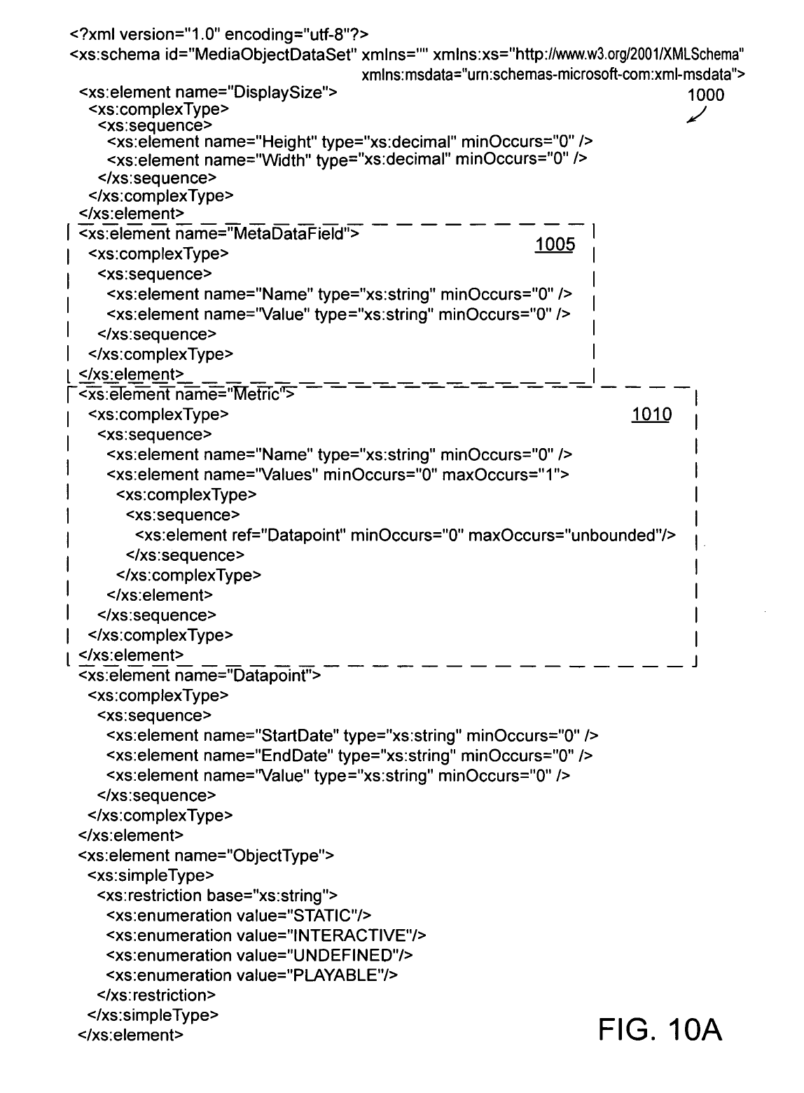

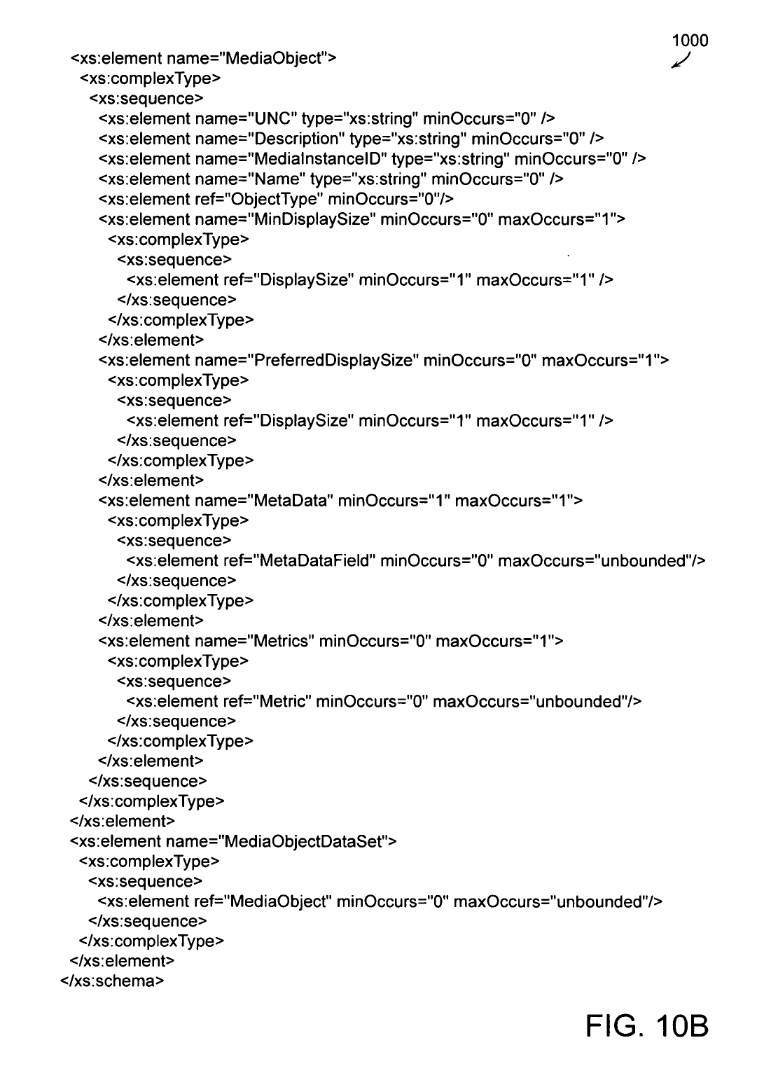

FIGS. 10A and 10B illustrate example extensible markup language (XML) code 1000 used to create a media software object, according to an embodiment of the present invention. Such XML code provides example elements used to implement the media software object 905 (FIG. 9) presented above. For example, the element named “MetaDataField” 1005 may be used to indicate a relationship between a particular creative asset and a particular marketing tactic, and the element named “Metric” 1010 may be used to indicate a relationship between a particular creative asset and an effect on the marketplace caused by the creative asset. In one embodiment, each file containing media software object XML code may be associated with one creative asset, but it should be understood that one file may represent multiple creative assets.

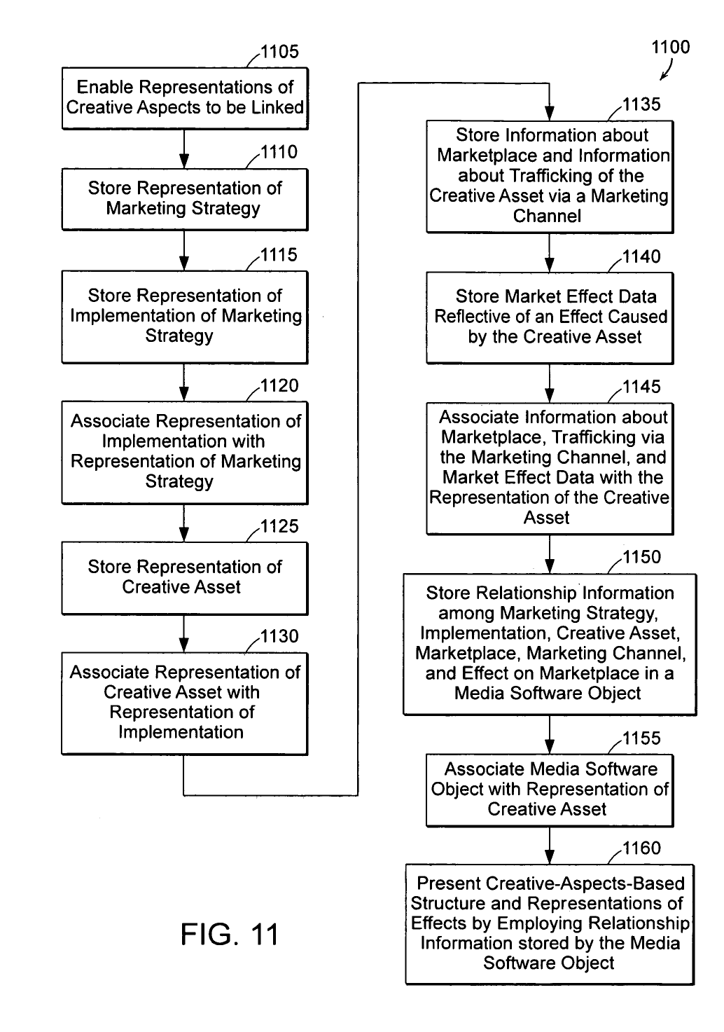

FIG. 11 is a flow diagram 1100 that illustrates visualizing a marketing strategy and its effects on a marketplace using a media software object, according to an embodiment of the present invention. Similar to the embodiments of FIGS. 5 and 8, representations of creative aspects of the marketing strategy are enabled to be linked together in a selectable manner (1105). The embodiment then stores a representation of the marketing strategy (1110) and a representation of an implementation of that strategy (1115), associates the representation of the implementation with the representation of the marketing strategy (1120), stores a representation of a creative asset used by the implementation (1125), and associates the representation of the creative asset with the representation of the implementation (1130). The embodiment then stores marketing information representing the marketplace and trafficking of the creative asset (1135) and market effect data reflecting an effect on the marketplace caused by the creative asset (1140).

As in the embodiment of FIG. 8, once this information is stored, the embodiment associates the information representing the marketplace, trafficking of the creative asset, and market effect data with the representation of a creative asset (1145). The embodiment then consolidates the representation of the marketing strategy, representation of the implementation, representation of the creative asset, marketing information, and market effect data to produce a media software object that stores relationship information among the marketing strategy, implementation of the marketing strategy, creative asset, marketplace, marketing channel, and effect by the creative asset on the marketplace (1150). This media software object is then associated with the related creative asset representation (1155). As in the embodiment of FIG. 8, a user-interactive, creative-aspects-based structure is then displayed in a graphical user interface, along with the representations of the effects of the marketing strategy, but is done so using the relationship information of the media software object (1160).

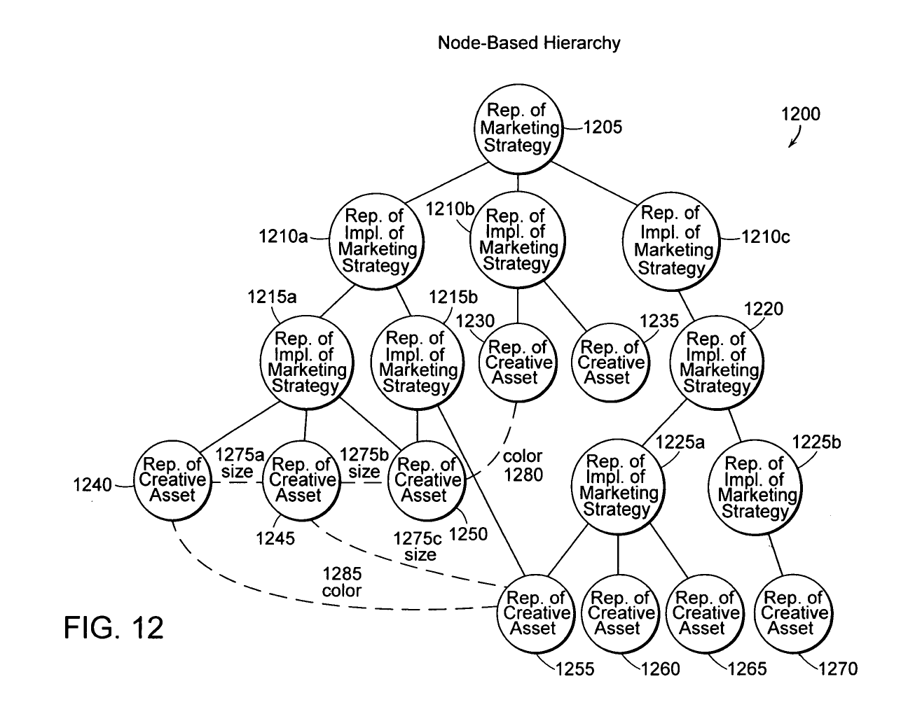

FIG. 12 is a hierarchical diagram illustrating a node-based hierarchy 1200 used to represent the relationship between a marketing strategy 1205, implementations of the marketing strategy 1210a-c, 1215a, 1215b, 1220, 1225a, 1225b, and creative assets 1230-1270 of the marketing strategy, according to an embodiment of the present invention. The node-based hierarchy 1200 is a hierarchy of nodes connected to each other in at least a parent-child manner. A given patent node may have multiple child nodes, and a given child node may have multiple parent nodes. The example node-based hierarchy 1200 has a root node 1205, intermediate nodes 1210a-c, 1215a, 1215b, 1220, 1225a, 1225b, and leaf nodes 1230-1270. According to the example embodiment, each node of the node-based hierarchy 1200 corresponds to one of the creative aspects of the marketing strategy. In many embodiments, the root node represents the marketing strategy, the leaf nodes represent the creative assets, and intermediate nodes represent the different implementations of the marketing strategy, that is, the particular contexts in which respective subsets of the creative assets are employed.

According to the example embodiment, the root node 1205 of such a node-based hierarchy represents the overall marketing strategy, and a plurality of child nodes 1210a-c of the root node 1205 represent different implementations of the marketing strategy. Child nodes 1215a, 1215b, 1220, 1230, 1235 of the nodes representing implementations 1210a-c may represent further sub-implementations of the marketing strategy 1215a, 1215b, 1220, or may represent creative assets 1230, 1235 used by the implementations. It should be noted that multiple implementations may use the same creative aspects. For example, with reference to their respective nodes, creative asset 1255 is used by both implementations 1215b and 1225a.

Other associations between the various creative aspects of the marketing strategy may be also be represented within the hierarchy 1200. Such other associations may include relationships between or among the various creative assets. As shown in FIG. 12, nodes 1240, 1245, 1250, and 1255 are connected by dashed lines 1275a-c. These associations 1275a-c among nodes 1240, 1245, 1250, and 1255 represent that the creative aspects corresponding to nodes 1240, 1245, 1250, and 1255 have a similar size. Similarly, dashed line 1280 represents a similarity in color between the creative aspects corresponding to nodes 1230 and 1250, and dashed line 1285 represents a similarity in color between the creative aspects corresponding to nodes 1240 and 1255. Such associations are not limited to size and color, but may include associations based on any metadata about the creative assets, such as metrics regarding the performance of the creative assets.

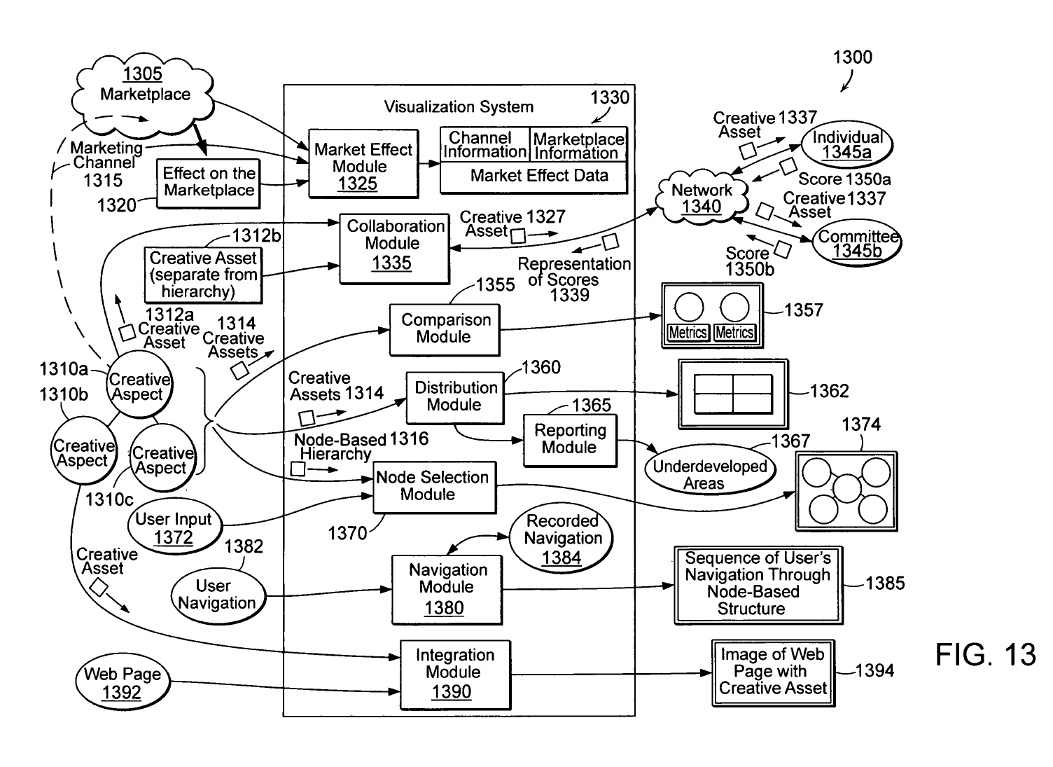

FIG. 13 is a block diagram illustrating a system 1300 for displaying a visualization of a marketing strategy and its effects on a marketplace, where the system includes a market effect module 1325, collaboration module 1335, comparison module 1355, distribution module 1360, reporting module 1365, node selection module 1370, navigation module 1380, and integration module 1390, according to an embodiment of the present invention. Although not shown in FIG. 13, it should be understood that the system 1300 includes a linking module, association module, and display module, as illustrated in FIG. 2B.

As in the embodiment of FIG. 6, the example embodiment includes a market effect module 1325 that stores marketing information about the marketplace 1305 and trafficking of a creative asset via a marketing channel 1315, as well as market effect data 1330 representing an effect 1320 on the marketplace 1305 caused by the creative asset. The example embodiment also includes a collaboration module 1335 that provides a creative asset 1137 to multiple entities 1345a, 1345b for feedback regarding potential performance of the creative asset 1337. The entities 1345a, 1345b provide scores 1350a, 1350b for the creative asset 1337, which are combined into a representation of the aggregated scores 1339. The collaboration module 1335 is described in more detail in other embodiments below. The example embodiment also includes a comparison module 1355 that compares the market effect data associated with the media software objects of respective creative assets 1314 and presents a side-by-side comparison view to a user 1357. The comparison module 1355 is described in more detail in other embodiments below. The example embodiment also includes a distribution module 1360 that sorts creative assets 1316 according to selected criteria and presents the creative assets as being distributed in a grid 1362 based on the criteria. A reporting module 1365 may also determine areas of the grid 1362 with the fewest creative assets and report those areas as indicating potentially underdeveloped marketing areas. The distribution and reporting modules 1360, 1365 are described in more detail in other embodiments below.

The example embodiment also includes a node selection module 1370 that, based on input 1372 from a user, displays a node-based structure 1374 used in visualizing the marketing strategy. The displayed node-based structure 1374 is based on at least a portion of the node-based hierarchy 1316. The node selection module 1370 is described in more detail in other embodiments below. The example embodiment also includes a navigation module 1380 that records a user's navigation 1382 through the creative-aspect-based structure and presents a similar navigation to the user at a later time, with data that likely differs from the data presented at the time of the recorded navigation 1384. The navigation module 1380 is described in more detail in other embodiments below. The example embodiment also includes a integration module 1390 that enables a temporary overlay of a selected creative asset 1318 onto an image of a web page and displays the resulting image of the web page with the integrated creative asset 1394. The integration module 1390 is described in more detail in other embodiments below.

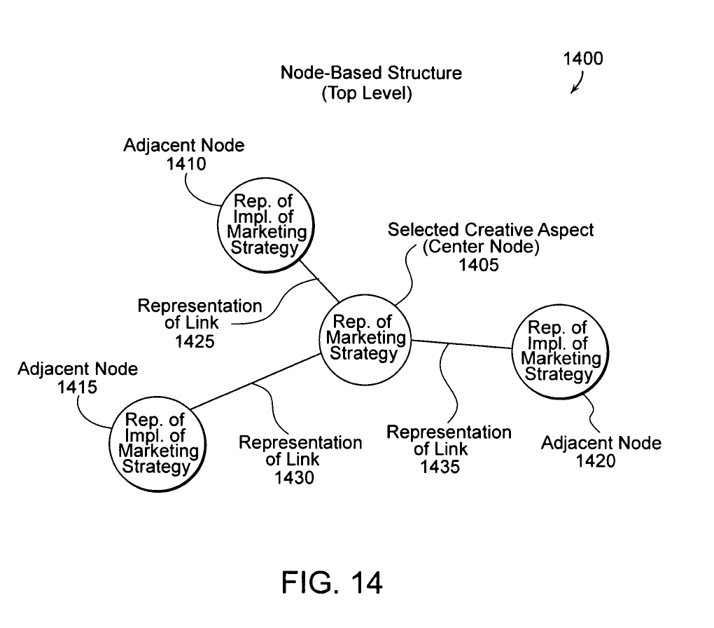

FIG. 14 is a schematic diagram illustrating a top-level view 1400 of a creative-aspects-based structure in the form of a node-based taxonomy, according to an embodiment of the present invention. The node-based taxonomy is a node-based structure, which is a graphical or pictorial structure that represents at least a portion of the nodes of a node-based hierarchy, such as the node-based hierarchy of FIG. 12. The structure may take the form of, for example, a central node 1405, with multiple nodes 1410, 1415, 1420 positioned apart from (e.g., surrounding) the central node 1405. Those multiple nodes 1410, 1415, 1420 may be the nodes in the node-based hierarchy that are directly connected to the central node 1405, based on either a parent-child relationship, other associations among the nodes, or both. Representations of the links 1425, 1430, 1435 between those nodes 1410, 1415, 1420 may be shown as lines connecting the nodes. It is important to note that central node 1405 is often referred to as the focus of the marketing strategy visualization, that is, an item, or group of items, of the representation of the marketing strategy that is intended to be the subject of current interest of a user. Often the focus of the visualization is arranged in the center of the representation, with closely related items being arranged apart from but near to the focus, such as around the center of the representation.

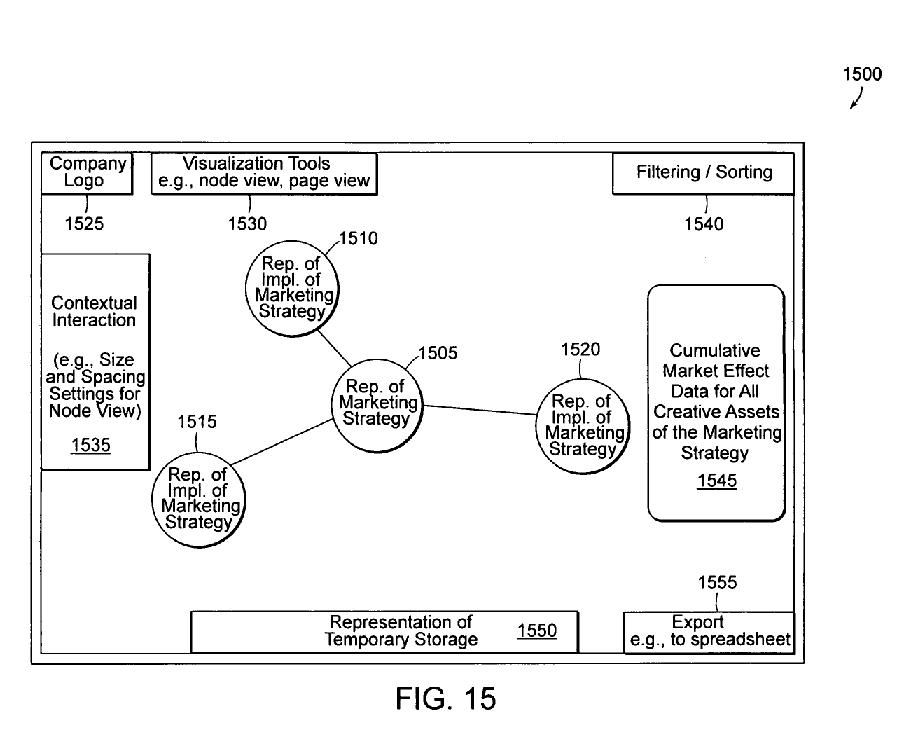

FIG. 15 is a schematic diagram illustrating a top-level view 1500 of a creative-aspects-based structure in the form of a node-based taxonomy and displayed via a graphical user interface, according to an embodiment of the present invention. Upon an initial display of the visualization of the marketing strategy, a node-based structure is presented that includes at least a subset of the nodes in the node-based hierarchy. In many embodiments, the central node 1505 of the initially displayed node-based structure represents the overall marketing strategy, and the nodes 1510, 1515, 1520 arranged apart from (e.g., around) and connected to the central node 1505 represent different implementations, or aspects, of the marketing strategy. Example aspects include different divisions within a company, marketing campaigns, geographic regions, and marketing channels.

The embodiment also presents a representation of the effects on the marketplace 1545 caused by the displayed aspects of the marketing strategy. When viewing the representation of the overall marketing strategy as the central focus, the representation of the effects on the marketplace 1545 includes the effects caused by all aspects of the marketing strategy. As the user navigates the node-based structure and focuses in on more detailed aspects of the marketing strategy, representations of only the effects caused by those more detailed aspects are displayed.

Also presented may be a company logo 1525, controls 1530 used to select various visualization tools (e.g., node view or page view), controls 1540 used to sort and filter the displayed representations, controls 1555 used to export the visualization to other formats (e.g., a spreadsheet format), and a representation of memory used for temporary storage. A contextual interaction section 1535 may also be presented, which includes different interfaces based on the various visualization tools presented via the graphical user interface. When displaying the node view, as shown in FIG. 15, setting interfaces affecting, for example, the size and spacing of the displayed node-based structure may be presented in the contextual interaction section 1535. As should be understood, other interfaces may be presented depending on the visualization tool being used at a given time by the user.

The example embodiment includes a node selection module (not shown) that enables a user to select one of the representations of the creative aspects to be a focus of the marketing strategy visualization. Upon selection of a particular representation, the node selection module causes a display module (not shown) to present, via the graphical user interface, the selected creative aspect representation as a central node 1505 of the node-based structure, to present adjacent nodes 1510, 1515, 1520 that are directly connected to or associated with the central node 1505 in the node-based hierarchy in positions apart from (e.g., surrounding) the central node 1505, and to present representations of links extending from the central node to each of the adjacent nodes 1510, 1515, 1520.

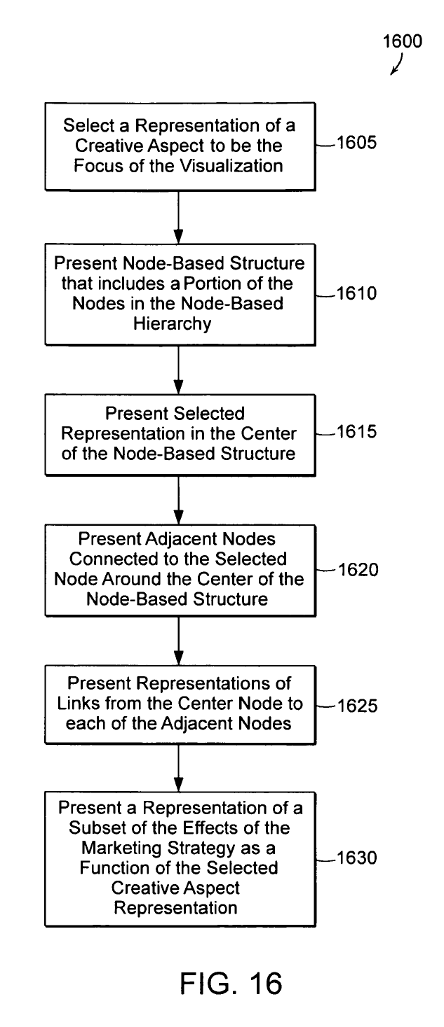

FIG. 16 is a flow diagram 1600 that illustrates a procedure for displaying portions of a node-based hierarchy (representing the relationship between a marketing strategy, implementations of the marketing strategy, and creative assets of the implementations) as a creative-aspects-based structure in the form of a node based taxonomy, according to an embodiment of the present invention. Upon selection of a representation of a creative aspect to be the focus of a visualization of a marketing strategy (1605), the example embodiment presents a node-based-structure that includes a portion of the nodes in the node-based hierarchy (1610). Within the node-based structure, the embodiment presents the selected representation of the creative asset in the center of the node-based structure (1615), presents adjacent nodes (i.e., nodes directly connected to or associated with the selected node in the node-based hierarchy) around the center node (1620), and presents representations of links from the center node to each of the adjacent nodes around the center node (1625). Also upon selection of the representation of the creative aspect to be the focus of the visualization, the embodiment presents a representation of a subset of the effects on the marketplace as a function of the selected creative aspect representation (i.e., the particular effects caused by the particular selected aspect are aggregated and presented to the user) (1630).

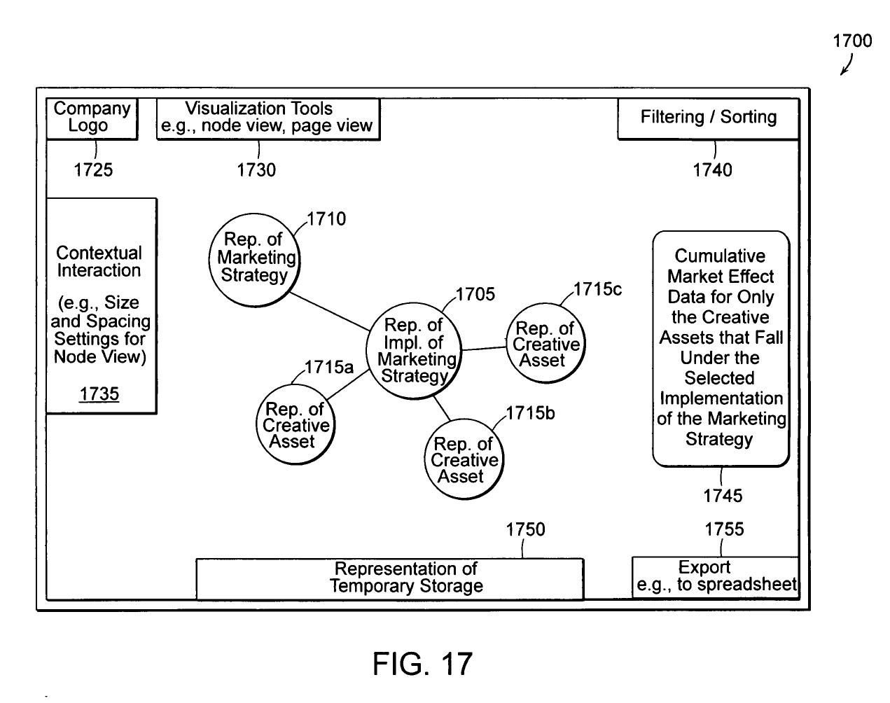

FIG. 17 is a screen view illustrating a lower-level view 1700 of a creative-aspects-based structure in the form of a node-based taxonomy and displayed via a graphical user interface, according to an embodiment of the present invention. The displayed node-based structure is similar to the initial top-level structure illustrated in FIG. 15, but is of a lower level in the node-based hierarchy. The view illustrated in FIG. 17 results from a selection of a node representing an implementation of the marketing strategy, which was previously displayed as an adjacent node connected to a central node representing the marketing strategy, for example, a selection of node 1520 from FIG. 15. Upon selection of the node 1520 (FIG. 15), the example embodiment displays the selected node as a new central node 1705, with adjacent nodes 1710, 1715a-c in positions apart from (e.g., near or surrounding) the new central node 1705. Adjacent node 1710 was the previous center node 1505 (FIG. 15). It should be noted that while many embodiments display only one level of adjacent nodes, other embodiments may display a specified number of levels of adjacent nodes, or may display a path of nodes from the selected node all the way up to the root node of the node-based hierarchy, (whether the path be via parent-child relationships between the nodes, via other associations represented in the hierarchy, or both), thus showing a user's history of node selections.

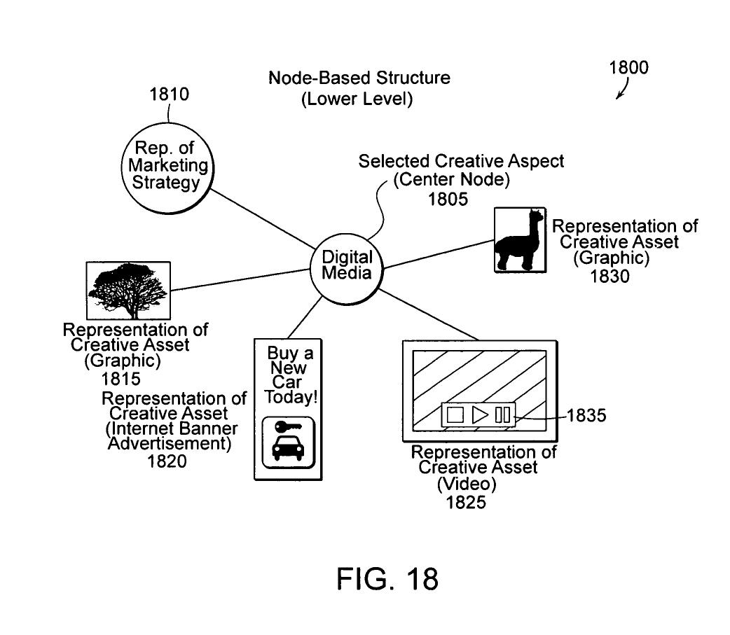

FIG. 18 is a screen view illustrating a lower-level view 1800 of a creative-aspects-based structure in the form of a node based taxonomy, where the leaf nodes of the structure are displayed in multi-media formats, according to an embodiment of the present invention. FIG. 18 shows a portion of the lowest level of the node-based hierarchy, that is, the displayed adjacent nodes are the leaf nodes of the hierarchy, which are representations of creative assets. Many embodiments display the representations of the creative assets in a multimedia format corresponding to the format of the associated creative assets.

Nodes 1815, 1820, 1825, and 1830 each represent a creative asset that exists in a digital medium; thus, they are represented as being related to node 1805, which, in the example embodiment, represents all digital media of the marketing strategy 1810. Nodes 1815, 1820, and 1830 represent creative assets that are graphics (e.g., JPEG or GIF files); thus, the example embodiment displays those nodes 1815, 1820, 1830 in a graphical format. Node 1825 represents a creative assets that is a video (e.g., MPEG movie file); thus, the example embodiment displays that node 1825 as a video, and may insert multimedia controls 1835 in the representation of the video 1825, such as play, stop, and pause buttons. Using these multimedia controls 1835, a user may control playback of the video 1825.

It should be noted that the lower-level view 1800 illustrated in FIG. 18 is merely one example. Examples of other lower-level views of the creative-aspects-based structure include views relating to the various marketing channels of the marketing strategy. One such marketing channel is related to social media, which may include social networking programs or websites (e.g., MySpace®), Internet web logs, and public forums.

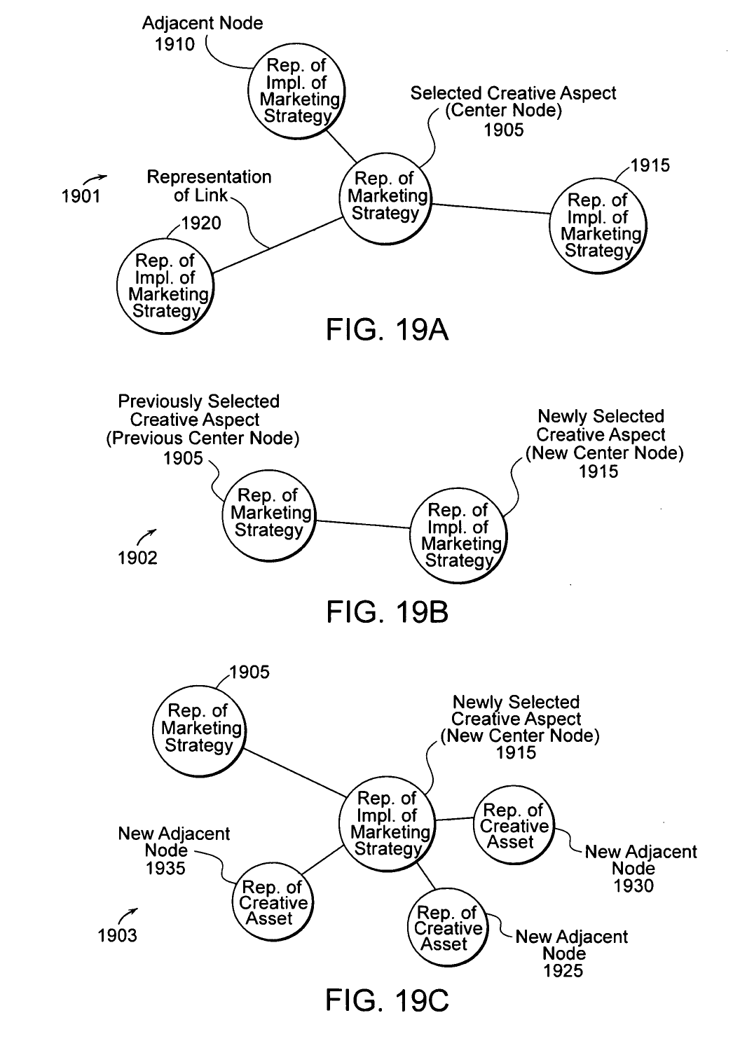

FIGS. 19A-19C are screen views 1901-1903 that illustrate a user's selecting a node of a displayed creative-aspects-based structure and changing the central focus to the selected node, according to an embodiment of the present invention.

FIG. 19A illustrates a node-based structure that is similar to the node-based structure of FIG. 15. Node 1905 is the center node (i.e., focus of the visualization) and nodes 1910, 1915, and 1920 are adjacent nodes. According to the example, a user selects node 1915 to become the new center node and, thus, changes the focus of the visualization from the previous center node to the new center node.

FIG. 19B illustrates that upon selection of the new node 1915, the example embodiment minimizes all other adjacent nodes 1910, 1920, and moves the newly selected node 1915 to a central location. The move may appear instantaneous (i.e., the selected node 1915 may jump from its previous location to a new, central location), or may appear as a gradual slide from the previous location to the new location.

FIG. 19C illustrates that once the newly selected node 1915 reaches its new, central location, the example embodiment displays new adjacent nodes 1925, 1930, 1935 that are directly connected to or associated with the new central node 1915 in the node-based hierarchy, and displays new representations of links extending from the new central node 1915 to each of the new adjacent nodes 1925, 1930, 1935. The new adjacent nodes 1925, 1930, 1935 may be displayed in positions apart from the central node 1915, such as surrounding the new central node 1915.

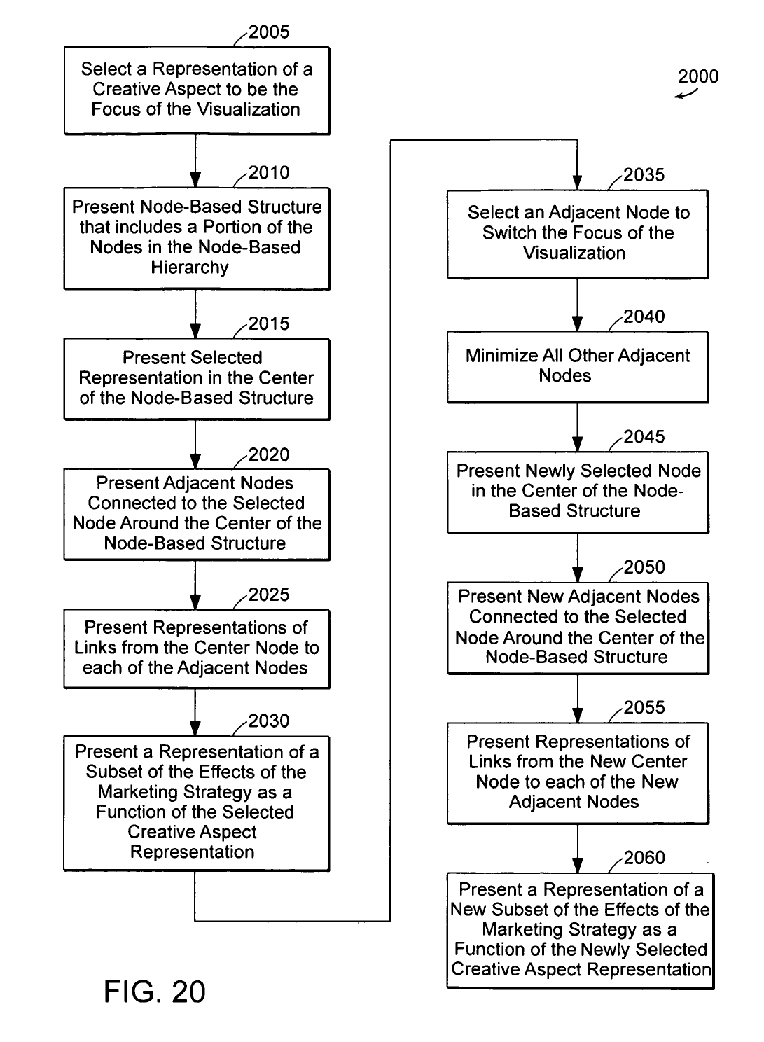

FIG. 20 is a flow diagram 2000 that illustrates selecting a node of a displayed creative-aspects-based structure and changing the central focus to the selected node, according to an embodiment of the present invention. As in the embodiment of FIG. 16, upon selection of a representation of a creative aspect to be the focus of a visualization of a marketing strategy (2005), the example embodiment presents a node-based-structure that includes a portion of the nodes in the node-based hierarchy (2010), presents the selected representation of the creative asset in the center of the node-based structure (2015), presents adjacent nodes (i.e., nodes directly connected to the selected node in the node-based hierarchy) around the center node (2020), presents representations of links from the center node to each of the adjacent nodes around the center node (2025), and presents a representation of a subset of the effects on the marketplace as a function of the selected creative aspect representation (2030). Upon selection of one of the adjacent nodes to switch the focus of the visualization to a representation of a new creative aspect of a marketing strategy (2035), the embodiment further minimizes all other adjacent nodes (2040) and presents the newly selected node in the center of the node-based structure (2045). Upon moving the selected node to the central location, the embodiment presents new adjacent nodes (i.e., nodes that are directly connected to the new central node in the node-based hierarchy) in positions around the center of the node-based structure (2050) and presents representations of links extending from the new central node to each of the new adjacent nodes (2055). The embodiment then presents a representation of a new subset of the effects on the marketplace as a function of the newly selected creative aspect representation (2060).

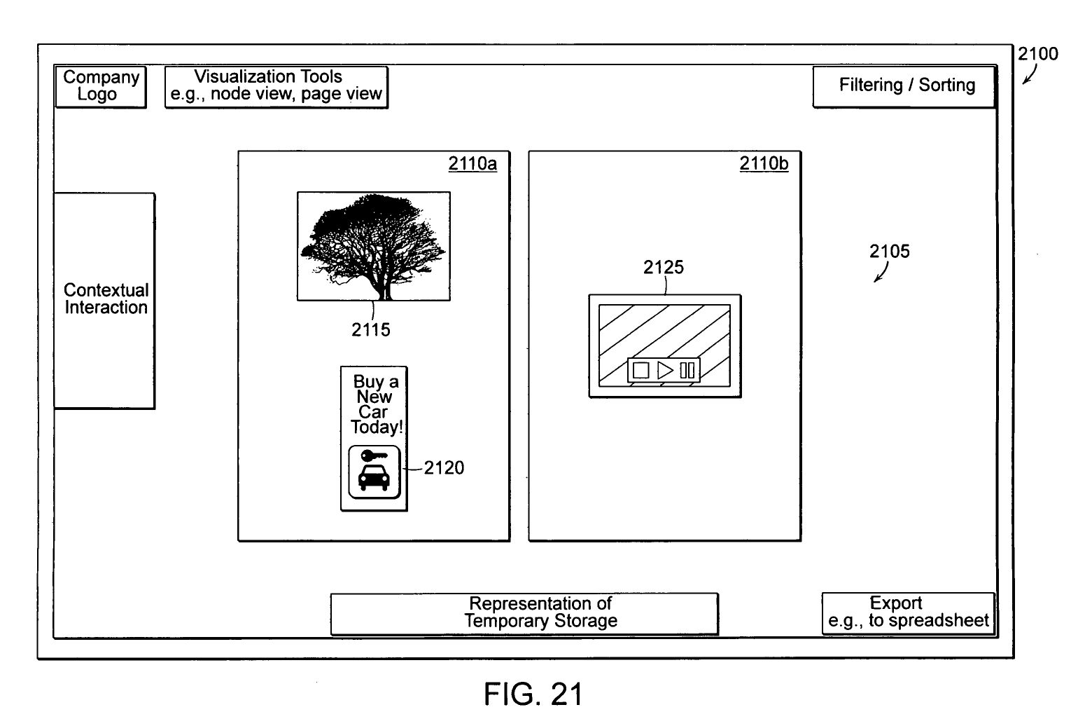

FIG. 21 is a screen view 2100 illustrating a dynamic page interface 2105 for displaying a plurality of creative assets 2115, 2120, 2125 in multi-media formats, according to an embodiment of the present invention. The dynamic page interface 2105 includes a number of electronic pages 2110a-b that mimic pages made of paper. Representations of at least a subset of the creative assets 2115, 2120, 2125 are displayed on the pages 2110a-b of the dynamic page interface 2105, and may be filtered or sorted according to a selected criteria. Sorting and filtering the representations 2115, 2120, 2125 involves comparing the representations' respective relationship information stored in the media software objects associated with the creative assets, and may include determining whether the representations 2115, 2120, 2125 are to be displayed in an ascending or descending order with respect to the selected criteria. Upon sorting and filtering the representations 2115, 2120, 2125, the dynamic page interface 2105 dynamically creates new electronic pages 2110a-b and presents the pages 2110a-b to the user. The dynamic page interface 2105 may be integrated with the node-based view by displaying only the representations of creative assets associated with nodes in levels of the node-based hierarchy that are connected to and at or below the level of the node corresponding to the currently selected creative aspect representation. As a user browses the pages 2110a-b of the dynamic page interface 2105, the electronic pages 2110a-b graphically turn, mimicking the functionality of paper pages.

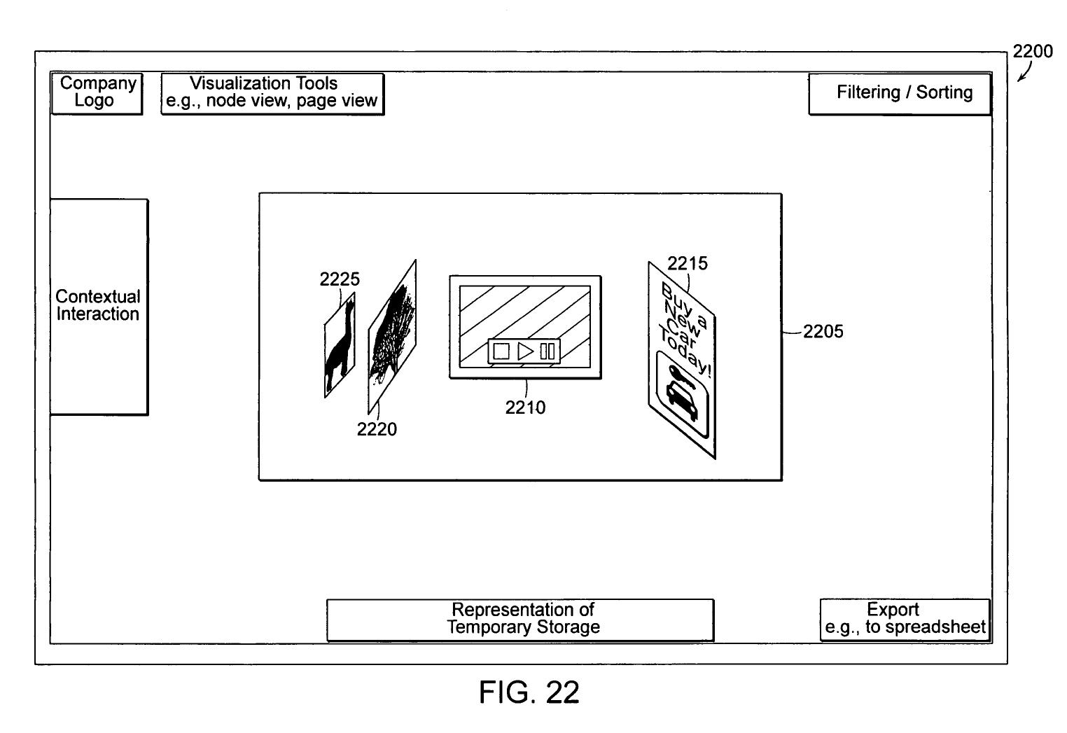

FIG. 22 is a screen view 2200 illustrating a linearly-flowing interface 2205 for displaying a plurality of creative assets 2210, 2215, 2220, 2225 in multi-media formats, according to an embodiment of the present invention. The linear interface 2205 presents representations of at least a subset of the creative assets 2210, 2215, 2220, 2225 along a line of display (typically horizontally) and may be filtered or sorted according to a selected criteria. Sorting and filtering the representations 2210, 2215, 2220, 2225 involves comparing the representations' respective relationship information stored in the media software objects associated with the creative assets, and may include determining whether the representations 2210, 2215, 2220, 2225 are to be displayed in an ascending or descending order with respect to the selected criteria. Upon sorting and filtering the representations 2210, 2215, 2220, 2225, the linearly-flowing interface 2205 dynamically creates a new view along the line of display and presents the new view to the user. As with the dynamic page interface, the linear interface 2205 may be integrated with the node-based view by displaying only the representations of creative assets associated with nodes in levels of the node-based hierarchy that are connected to and at or below the level of the node corresponding to the currently selected creative aspect representation. Further, the representations of the creative assets may be uniformly distributed along the linear interface or may be displayed in a position along the linear interface based on a specified attribute of its respective relationship information and relative to the other creative assets' respective relationship information.

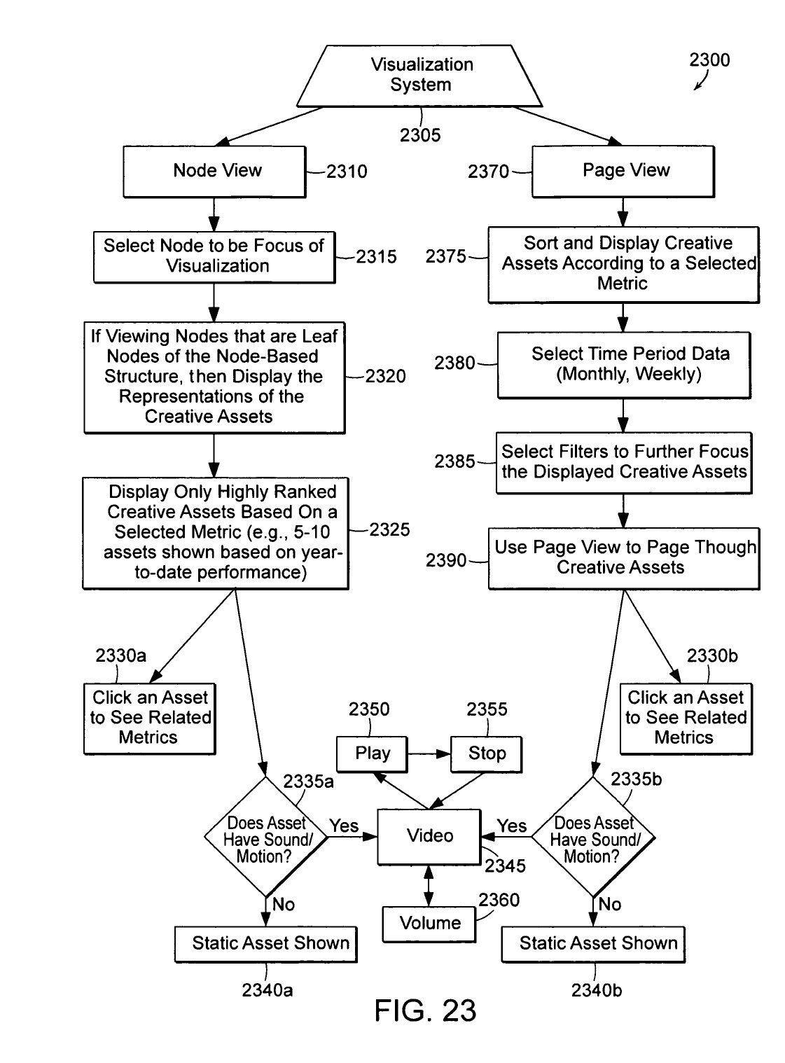

FIG. 23 is a flow diagram 2300 that illustrates displaying a plurality of creative assets in different screen views, according to an embodiment of the present invention. Embodiments of the marketing strategy visualization system may include many different views in which visualizations are presented to a user. Two such views are a node view 2310 and a page view 2370. Using the node view, a user selects a node to the focus of the visualization (2315). If the view of the selected node results in the leaf nodes (creative assets) of the related node-based structure being displayed, then the node view may display the representations of the creative assets in a multimedia format (2320). To prevent cluttering of many creative asset representations, the node view may only display the highest ranked creative assets (2325). Such a ranking may be determined based a selected metric, such as year-to-date performance of the creative assets. Once a creative asset representation is displayed, the user may click on the representation with a cursor to view metrics (market effect data) related to that creative asset (2330a). If the creative asset has sound or motion, such as in the case of music or a video (2335a), then the node view displays the music or video (2345), and the user may control the playback of the music or video (2350, 2355, 2360). If the creative asset does not have sound or motion, then a static representation is shown (2340a).

Using the page view, a user may sort and display creative assets according to a selected criteria (2375). The user may also specify a particular granularity in which to display the creative asset representations (e.g., select a particular time period, such as monthly or weekly) (2380), and may further filter the displayed representations (2385). Using the electronic pages of the page view, the user may page though the creative asset representations (2390). As with the node view, the creative asset representations are displayed in a multimedia format, and the user may click on a representation with a cursor to view metrics (market effect data) related to that creative asset (2330b). If the creative asset has sound or motion, such as in the case of music or a video (2335b), then the page view displays the music or video (2345), and the user may control the playback of the music or video (2350, 2355, 2360). If the creative asset does not have sound or motion, then a static representation is shown (2340b).

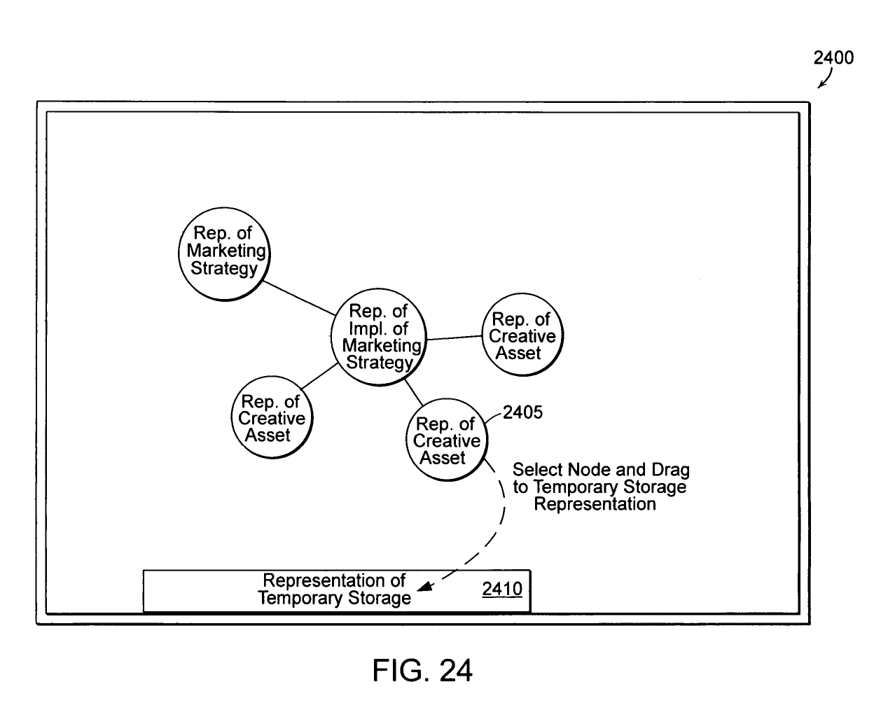

FIG. 24 is a screen view 2400 that illustrates a user's selecting a creative asset of a displayed creative-aspects-based structure and temporarily storing a media software object associated with the creative asset to be applied to another environment, according to an embodiment of the present invention. The node selection module of the example embodiment enables a user to select a node representing a creative asset 2405 of the node-based structure and to “drag and drop” the node 2405 onto a representation of temporary memory 2410. As a result of doing so, the media software object associated with the creative asset is temporarily added to memory. From the memory, the media software object, and associated creative asset, may be applied to an environment other than the creative-aspects-based structure, such as other applications or program modules. When added to the memory, a representation of the creative asset as added to the memory is presented via the graphical user interface.

Embodiments also include an integration module used to overlay such a representation of a creative asset, which has been added to the memory, onto an image of a web page, resulting in an image of a web page that includes the creative asset. In some embodiments, only the media software object is added to the memory, and the creative asset representation associated with the media software object is retrieved when a user applies the media software object to other environments. This approach is more efficient as the media software object is generally a smaller sized file as compared to a representation of a creative asset.

Embodiments also include a comparison module that enables a user to select multiple media software objects via the displayed representations of the creative assets, and that compares the respective market effect data associated with the media software objects. Such a comparison may be displayed to the user via the graphical user interface by presenting the multiple creative asset representations along with their associated market effect data.

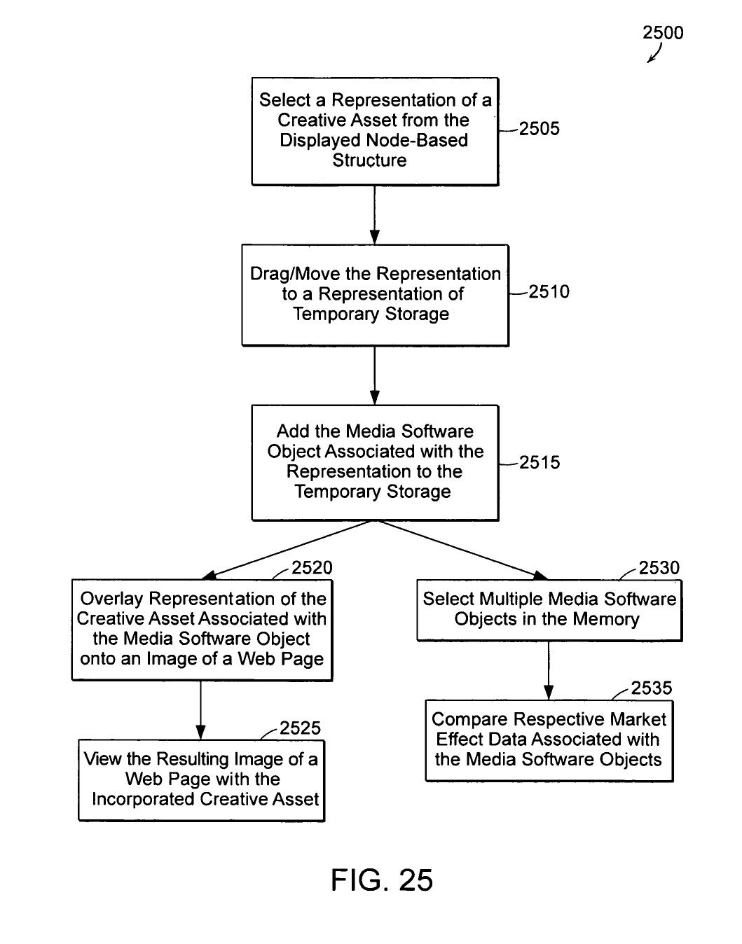

FIG. 25 is a flow diagram 2500 that supports a user's selecting a creative asset of a displayed creative-aspects-based structure, temporarily storing a media software object associated with the creative asset, and taking further action with the creative asset, according to an embodiment of the present invention. Upon selecting a representation of a creative asset from the displayed node-based structure (2505), a user may drag, or move, the representation to a representation of memory used as temporary storage (2510). As a result of the move, the media software object associated with the creative asset representation is added to the memory (2515).

According to the example embodiment, the representation of the creative asset associated with the media software object may be overlaid onto an image of a web page (2520) and the resulting image of the web page with the incorporated creative asset may be displayed to the user (2525). Alternatively, the user may select multiple media software objects that have been added to the memory (2530) and compare respective market effect data that is associated with the multiple media software objects (2535).

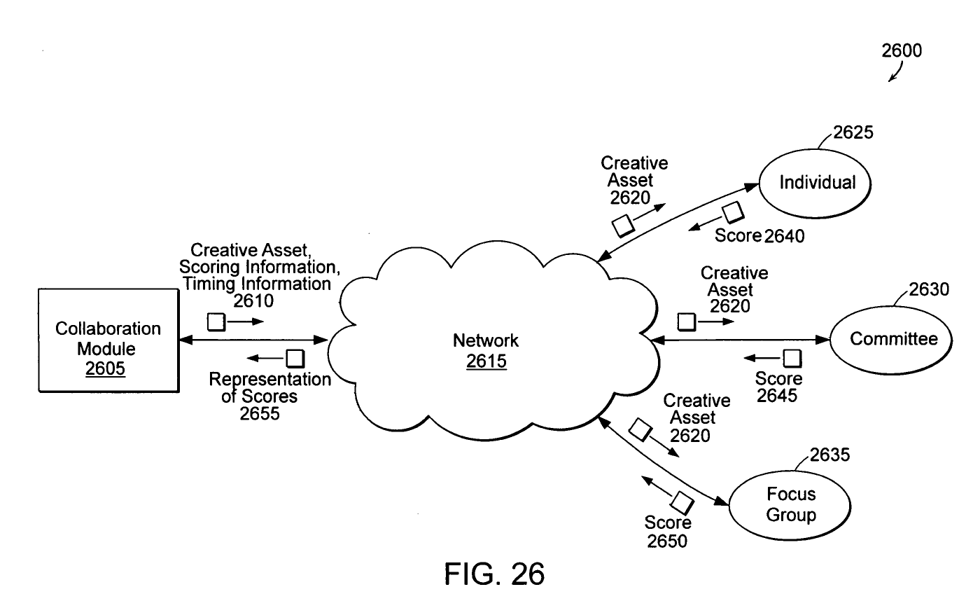

FIG. 26 is a network diagram 2600 that illustrates providing a creative asset 2620 to a plurality of entities 2625, 2630, 2635 for feedback regarding potential performance of the creative asset 2620 and obtaining a score 2655 for the creative asset 2620, according to an embodiment of the present invention. Embodiments may include a collaboration module 2605 that is used as a fast, elegant mechanism to obtain feedback about a creative asset from individuals 2625, 2635 and groups 2630, such as colleagues, peers, experts, committees, focus groups, or even selected or unselected Internet users. These entities may be internal with respect to an organization, such as co-workers, or external with respect to the organization, such as focus groups or Internet users.

The collaboration module 2605 provides the creative asset 2620 to multiple such entities 2625, 2635, 2630 for feedback regarding potential performance of the creative asset 2620, and obtains a score 2640, 2645, 2650 for the creative asset 2620 from each entity 2625, 2635, 2630. The resulting score 2655 for the creative asset 2620 may be the multiple scores 2640, 2645, 2650 from each entity 2625, 2635, 2630, or may be a representation of the scores 2640, 2645, 2650, such as an average of the scores 2640, 2645, 2650. The collaboration module 2605 is a one-to-many instant-messaging-style file sharing program that alleviates the problem of overwhelming emails by proving the participants with simple actions, such as performing a single click of a mouse. It should be noted that the collaboration module 2605 may be implemented as part of a larger overall system or may exist as a stand-alone system.

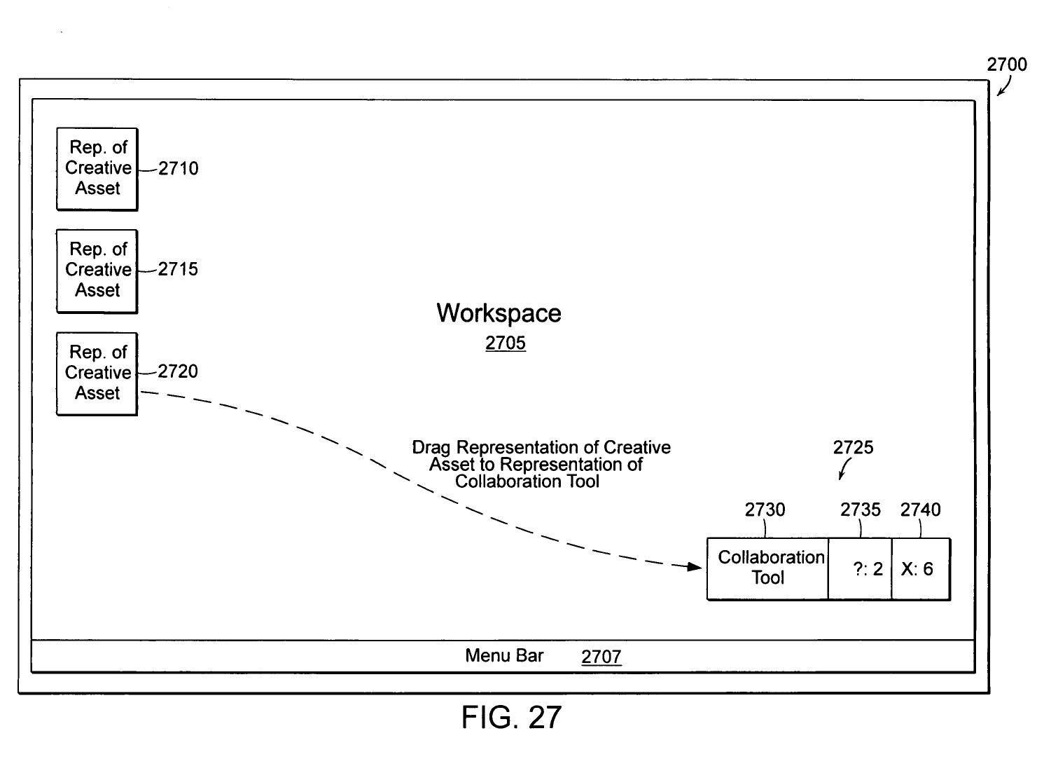

FIG. 27 is a screen view illustrating an example graphical user interface 2700 including a collaboration tool for providing a creative asset to a plurality of entities for feedback, according to an embodiment of the present invention. The graphical user interface of the example embodiment includes a user's workspace 2705, a operating system's menu bar 2707, representations of creative assets (e.g., icons) 2710, 2715, 2720, and a collaboration module interface 2725. The example collaboration module interface 2725 includes a title 2730, an indication of the number of creative assets submitted by the user 2735 viewing the particular collaboration module interface 2725, and the number of creative assets that the user needs to score 2740, that is, creative assets submitted by other entities. To begin the collaboration process, the user need only “drag and drop” a representation of a creative asset 2720 to the collaboration module interface 2725.

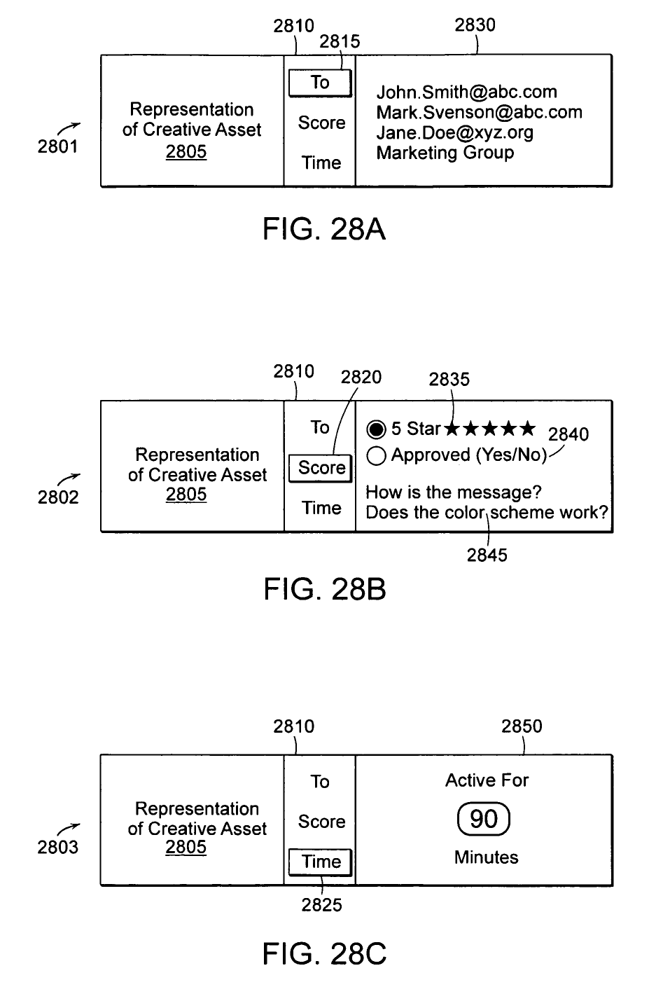

FIGS. 28A-28C are screen views illustrating example interfaces 2801-2803 for providing a creative asset to a collaboration tool for the purpose of receiving feedback from a plurality of entities, according to an embodiment of the present invention. According to the example embodiment, upon initiating the collaboration process, the collaboration module interface 2801 presents the user with a representation of the creative asset 2805, which may also provide an indication of the status of an upload of the creative asset to the collaboration system/module. The interface 2801 also presents a selection element 2810 used to specify what type of data the user will enter in the data input element 2830. In the case of the interface 2801 of FIG. 28A, the “To” option 2815 has been selected and, thus, the user enters information into the data input element 2830 specifying to what entities the creative asset is to be sent for feedback.

Interface 2802 is similar to interface 2801, except that the “Score” option 2820 of the selection element 2810 has been selected, and that the user enters into the data input element the type of feedback that the user desires regarding the creative asset. In the example embodiment, the user has two options: a five-star rating 2835 and an indication of whether the scoring entity approves of the creative asset 2840. The user may also provide comments 2845 as to an aspect of the creative asset on which the scoring entities should focus. Interface 2803 is similar to interfaces 2801 and 2802, except that the “Time” option 2825 of the selection element 2810 has been selected, and that the user enters into the data input element the amount of time 2850 that the scoring entities have to respond with a score for the creative asset.

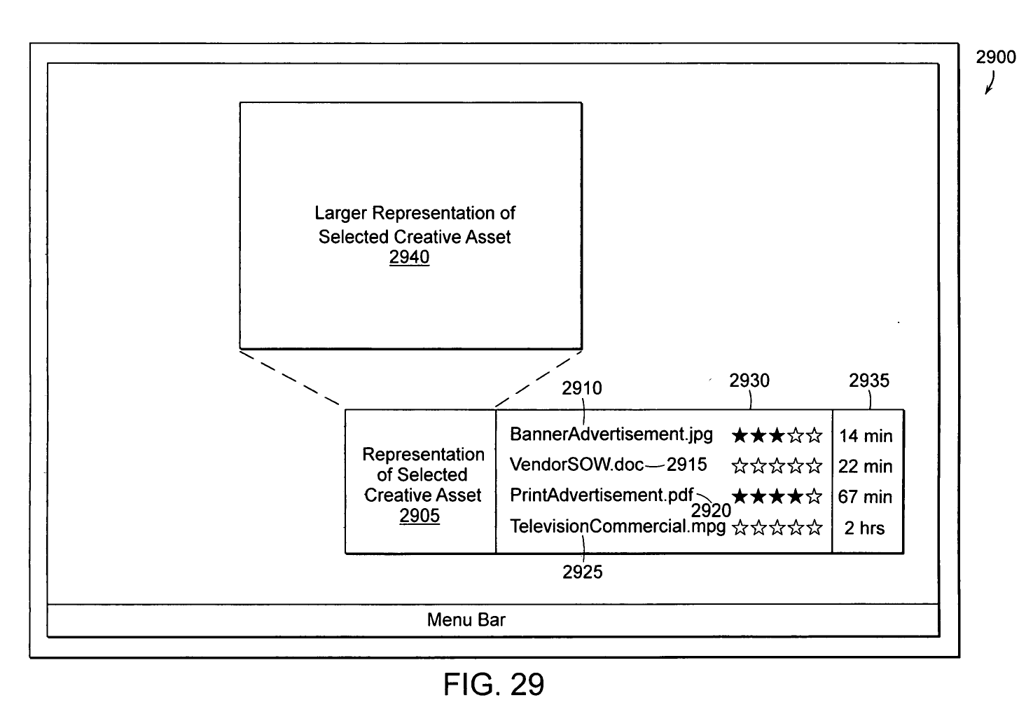

FIG. 29 is a screen view illustrating an example interface 2900 for providing feedback regarding a creative asset provided by another entity, according to an embodiment of the present invention. The interface 2900 is similar for a scoring entity in that the interface 2900 presents the representation of the creative asset 2905 to be scored, but also provides a list of creative assets to be scored by the entity 2930. The interface 2900 also presents to the scoring entity the amount of time remaining for the entity to score each of the creative assets 2935. To view a particular representation of a creative asset, the entity need only click on an element in the list of creative assets 2930.

Upon selecting a creative asset, the representation of the creative asset 2905 is displayed. To view a larger representation of the creative asset 2940, the entity may click on the smaller representation of the creative asset 2905. To score the selected creative asset, the user may select the number of stars of the example five-star rating presented adjacent to the list of creative assets 2930 by clicking on the star corresponding to the desired rating. According to the example interface, the entity has submitted scores for creative assets 2910 and 2920, but has not yet submitted scores for creative assets 2915 and 2925.

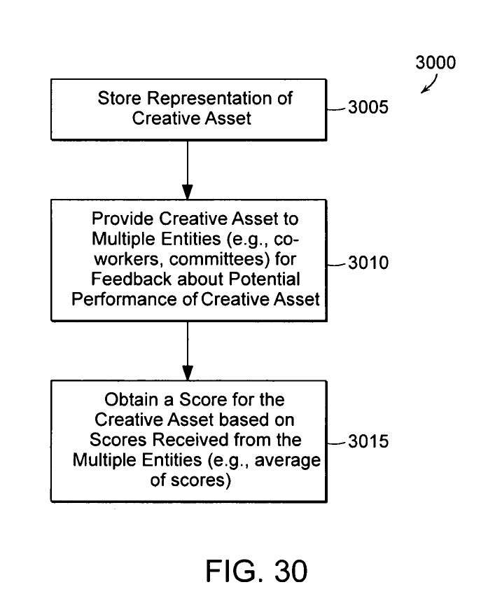

FIG. 30 is a flow diagram 3000 that illustrates providing a creative asset to a plurality of entities for feedback regarding potential performance of the creative asset and obtaining a score for the creative asset, according to an embodiment of the present invention. Upon storing a representation of a creative asset (3005), the creative asset is provided to multiple entities for feedback regarding the potential performance of the creative asset (3010). The embodiment then obtains a score for the creative asset based in the scores received from the multiple entities (3015). Each score may indicate what entity provided the score, or the scores may be anonymous.

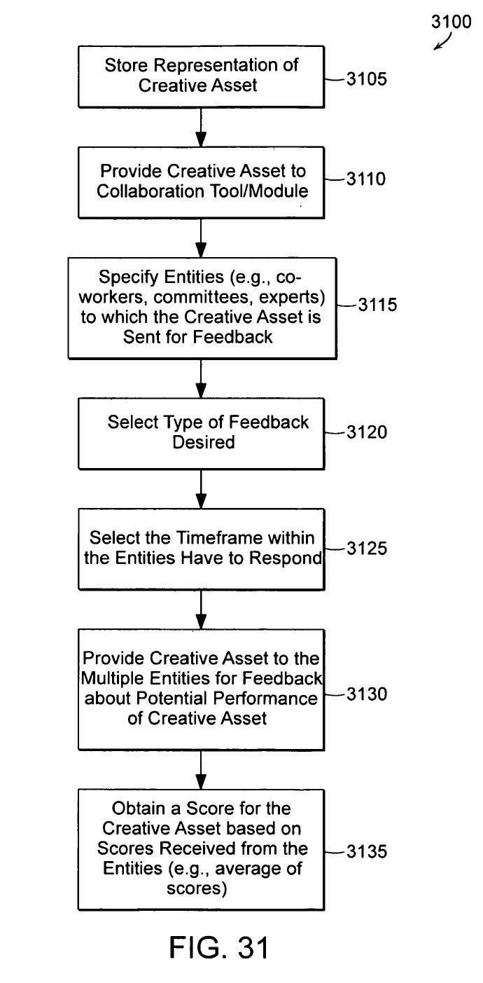

FIG. 31 is a flow diagram 3100 that illustrates specifying further detailed information when providing a creative asset to a plurality of entities for feedback regarding potential performance of the creative asset, according to an embodiment of the present invention. Upon storing a representation of a creative asset (3105), a user provides the creative asset to a collaboration system/module (3110), specifies the entities to which the creative asset is to be sent for feedback (3115), selects the type of feedback desired (3120), and selects the timeframe within the specified entities have to respond with feedback (3125). The example embodiment then provides the creative asset to the specified entities for their feedback regarding the potential performance of the creative asset (3130) and obtains a score for the creative asset based on scores received from the specified entities (3135).

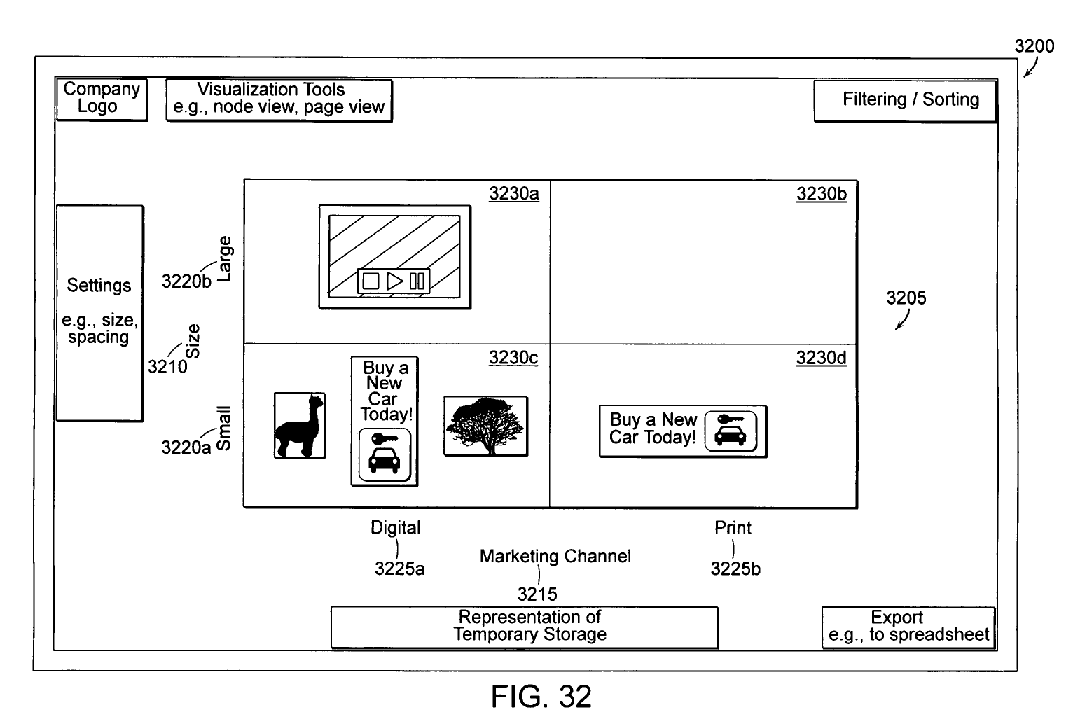

FIG. 32 is a screen view 3200 illustrating an output of a distribution module that sorts and presents creative assets distributed in a two-dimensional grid 3205, according to an embodiment of the present invention. Embodiments may include a distribution module that sorts creative assets according to one or more criteria and presents the creative assets in a two-dimensional grid 3205. This grid 3205 may be used to view the distribution of the creative assets and to determine what marketing areas are potentially under- or over-developed.

The creative assets are distributed along one of the axis of the grid 3205 according to a first criteria, such as the marketing channel 3215 of the creative assets, as shown in the example embodiment of FIG. 23. The creative assets are also distributed along the other axis of the grid 3205 according to a second criteria, such as the size 3210 of the creative assets, as also shown in the example embodiment. For simplification purposes, the grid 3205 of the example embodiment has been limited to two columns and two rows, but may include any number of columns or rows. Also for simplification purposes, the grid 3205 of the example embodiment has been limited to two dimensions; other embodiments may include more dimensions. The two marketing channels 3215 of the example embodiment are digital 3225a and print 3225b marketing channels, and the two sizes 3210 are small 3220a and large 3220b (e.g., as measured in inches or pixels).

The embodiments may also include a reporting module that determines from the grid 3205 which areas, or squares, 3230a-d of the grid are potentially under- or over-developed by determining the areas with the fewest or most creative assets, respectively. For example, area 3230b does not include any creative assets and may be considered to be potentially under-developed, while area 3230c includes the most creative assets and may be considered to be potentially over-developed. The reporting module may report these areas to a user of the system and may further report the values of the criteria corresponding to those areas, for example, reporting the values of “large” and “print” as representing a marketing area that is potentially under-developed, or reporting the values of “small” and “digital” as representing a marketing area that is potentially over-developed.

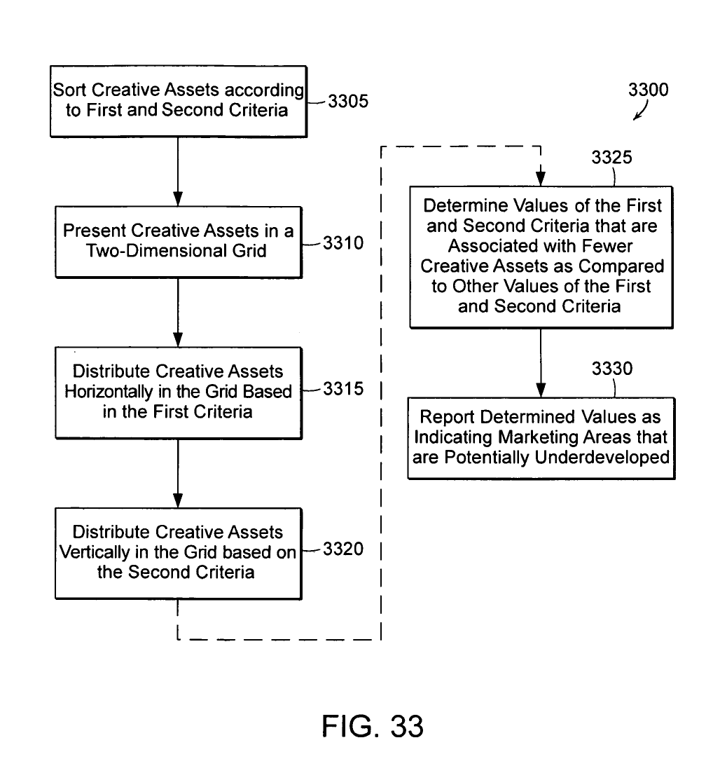

FIG. 33 is a flow diagram 3300 that illustrates sorting and presenting creative assets distributed in a two-dimensional grid, and optionally determining and reporting marketing areas that are potentially underdeveloped based on the distribution. According to an example embodiment, creative assets are sorted according to a first and second criteria (3305) and presented in a two-dimensional grid (3310). The example embodiment distributes the creative assets horizontally in the grid based on the first criteria (3315) and distributes the creative assets vertically in the grid based on the second criteria (3320). The embodiment may also optionally (represented by the dashed line) determines the values of the first and second criteria that are associated with fewer creative assets as compared to other values (3325), and reports the determined values as indicating a marketing area that is potentially under-developed (3330). As presented above, the embodiment may also similarly determines and reports marketing areas that are potentially over-developed.

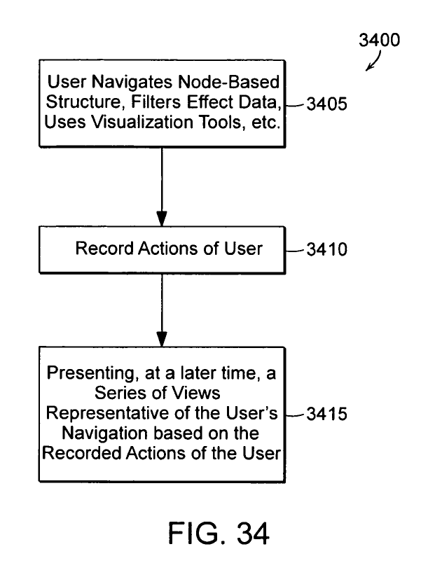

FIG. 34 is a flow diagram 3400 that illustrates recording a user's sequence of navigation through a creative-aspects-based structure and presenting, at a later time, a series of views of the creative-aspects-based structure that represent the user's sequence of navigation, according to an embodiment of the present invention. Navigation of a node-based structure refers to the actions by which a user manipulates a node-based structure (e.g., by selecting different nodes of the structure to be the central node, or focus) to view the various aspects of the structure. A sequence of such a navigation is the series of views of the node-based structure that result from the manipulation of the structure.

Embodiments may include a navigation module that upon a user navigating the node-based structure (e.g., selecting various nodes as being the focus of the visualization of the marketing strategy) (3405), recording the actions of the user (3410). At a later time, the navigation module may present a series of views of the later node-based structure based on the recorded actions of the user (3415). For example, if a user's recorded actions include viewing market effect data for advertisements displayed in Australia and then viewing market effect data for every Internet banner advertisement, the navigation module presents, at a later time, a series of views including viewing market effect data for advertisements displayed in Australia and then viewing market effect data for every Internet banner advertisement, likely showing different, up-to-date market effect data at that later time, even if, for example, the number of Internet banner advertisement has changed.

While this invention has been particularly shown and described with references to example embodiments thereof, it will be understood by those skilled in the art that various changes in form and details may be made therein without departing from the scope of the invention encompassed by the appended claims.

It should be understood that the flow diagrams of FIGS. 2A, 5, 8, 11, 16, 20, 23, 25, 30, 31, 33, and 34 are examples that can include more or fewer components, be partitioned into subunits, or be implemented in different combinations. Moreover, the flow diagrams may be implemented in hardware, firmware, or software. If implemented in software, the software may be written in any software language suitable for use in systems as illustrated in FIGS. 1, 2B, 3, 6, 7, 13, 26. The software may be embodied on any form of computer readable medium, such as RAM, ROM, or magnetic or optical disk, and loaded and executed by generic or custom processor(s).

What is claimed is:

1. A system for enabling a user to visualize a marketing strategy and its effects on a marketplace, the system comprising:
a linking module to enable representations of creative aspects of the marketing strategy to be linked together in a selectable manner;
an association module to associate representations of the effects of the marketing strategy on the marketplace with the representations of the creative aspects; and
a display module to present, via a graphical user interface, at least a subset of the representations of the creative aspects in a user-interactive, creative-aspects-based structure and the representations of the effects of the marketing strategy in a manner enabling the user to interact with the representations of the creative aspects and the representations of the effects to visualize the marketing strategy and its effects on the marketplace.

2. A system as in claim 1 wherein at least one of the creative aspects is a creative asset and at least one of the representations of the creative aspects is a representation of the creative asset; and
further including a market effect module to:
store marketing information representing (i) the marketplace having a plurality of marketing channels and (ii) trafficking of the creative asset via at least one of the marketing channels;
store market effect data reflective of an effect on the marketplace caused by the creative asset; and
associate the marketing information and the market effect data with the representation of the creative asset.

3. A system as in claim 1 further including:
a representation of the marketing strategy;
wherein at least a first of the creative aspects is an implementation of the marketing strategy and at least a first of the representations of the creative aspects is a representation of the implementation of the marketing strategy, the representation of the implementation of the marketing strategy being associated with the representation of the marketing strategy; and
wherein at least a second of the creative aspects is a creative asset and at least a second of the representations of the creative aspects is a representation of the creative asset, the representation of the creative asset being associated with the representation of the implementation of the marketing strategy.

4. A system as in claim 3 further including:
a collaboration module to provide at least one of the creative assets to a plurality of entities for feedback regarding potential performance of the creative asset and to obtain a score for the creative asset based on the scores provided by each entity.

5. A system as in claim 3 further including a market effect module to:
store marketing information representing (i) the marketplace having a plurality of marketing channels and (ii) trafficking of the creative asset via at least one of the marketing channels;
store market effect data reflective of a given effect on the marketplace caused by the creative asset; and
associate the marketing information and the market effect data with the representation of the creative asset.

6. A system as in claim 5 further including:
a media software object associated with the representation of the creative asset, the media software object including:
a consolidation of the representation of the marketing strategy, representation of the implementation of the marketing strategy, representation of the creative asset, marketing information, and market effect data; and
stored relationship information among the marketing strategy, implementation of the marketing strategy, creative asset, marketplace, marketing channel, and given effect on the marketplace; and
wherein the display module employs the relationship information of the media software object in a user-selectable manner to present the user-interactive, creative-aspects-based structure and the representations of the effects of the marketing strategy.

7. A system as in claim 6 further including:
a node-based hierarchy having a root node, intermediate nodes, and leaf nodes, each node of the node-based hierarchy corresponding to one of the representations of the creative aspects and being directly connected to at least one other node.

8. A system as in claim 7 wherein the root node of the node-based hierarchy represents the marketing strategy, wherein the leaf nodes of the node-based hierarchy represent the creative assets, and wherein each intermediate node represents a particular context in which a respective subset of the creative assets, represented by the child leaf nodes of the intermediate node, is employed.

9. A system as in claim 8 further including:
a node selection module to enable the user to select one of the representations of the creative aspects to be a focus of the marketing strategy visualization, resulting in a selected creative aspect representation, and to cause the display module to:
present a node-based structure that includes at least a subset of the nodes in the node-based hierarchy;
present the selected creative aspect representation as a central node of the node-based structure;
present adjacent nodes that are directly connected to the central node in the node-based hierarchy in positions apart from the central node; and
present representations of links extending from the central node to each of the adjacent nodes.

10. A system as in claim 9 wherein the display module presents a representation of a subset of the effects of the marketing strategy on the marketplace as a function of the selected creative aspect representation.

11. A system as in claim 9 wherein the representations of the creative assets are multimedia representations of the creative assets; and
wherein the display module presents each leaf node of the node-based structure in a multimedia format corresponding to the multimedia format of the creative asset represented by the node.

12. A system as in claim 11 wherein the display module inserts multimedia controls into the representations of the creative assets.

13. A system as in claim 9 wherein the node selection module enables the user to select one of the adjacent nodes, resulting in a selected adjacent node, to change focus from the central node to the selected adjacent node; and
wherein, upon a change in focus from the central node to the selected adjacent node, the node selection module causes the display module to:
minimize all other adjacent nodes;
present the selected adjacent node as a new central node;
present new adjacent nodes that are directly connected to the new central node in the node-based hierarchy in positions apart from the new central node; and
present representations of links extending from the new central node to each of the new adjacent nodes.

14. A system as in claim 13 further including:
a navigation module to record the user's sequence of navigation through the node-based structure and to cause the display module to present, at a later time, a series of views of the node-based structure that represent the user's sequence of navigation through the node-based structure.

15. A system as in claim 9 wherein the node selection module enables the user to:
select a representation of a creative asset corresponding to a node of the presented node-based structure, the representation of the creative asset being associated with a media software object;
temporarily add the media software object to a memory from which the media software object is accessed to be applied to an environment other than the creative-aspects-based structure; and
wherein the display module presents a representation of the memory including the creative asset associated with the media software object added to the memory.

16. A system as in claim 15 further including:
an integration module to overlay a representation of the creative asset associated with the media software object onto an image of a given web page to view a resulting image of a web page that includes the creative asset.

17. A system as in claim 15 further including:
a comparison module to enable selection of multiple media software objects in the memory and to compare the respective market effect data associated with the media software objects.

18. A system as in claim 9 further including:
a dynamic page view interface having a plurality of electronic pages, the dynamic page view interface presenting representations of at least a subset of the creative assets via the electronic pages and being dynamically created based on sorting and filtering of the creative assets according to specified criteria and the relationship information of the media software objects associated with the creative assets.

19. A system as in claim 18 wherein the dynamic page view interface is dynamically created based on representations of creative assets associated with nodes in levels of the node-based hierarchy that are at or below the level of the node corresponding to the selected creative aspect representation.

20. A system as in claim 9 further including:
a dynamic linear interface that presents representations of creative assets in a linear fashion, the dynamic linear interface being dynamically created based on sorting and filtering of the creative assets according to specified criteria and the relationship information of the media software objects associated with the creative assets.

21. A system as in claim 20 wherein each representation of a creative asset is displayed in a position within the linear interface based on a specified attribute of its respective relationship information and relative to the other creative assets' respective relationship information.

22. A system as in claim 9 further including a distribution module to sort at least a subset of the creative assets according to first and second criteria and to present the creative assets in a two-dimensional grid, the creative assets being distributed along a first edge of the grid based on the first criteria and being distributed along a second edge of the grid based on the second criteria.

23. A system as in claim 22 further including a reporting module to:
determine, from the two-dimensional grid, first and second values of the respective first and second criteria being associated with fewer creative assets than that of other values of the first and second criteria; and
report the first and second values as indicating potentially underdeveloped areas of marketing.

24. A method of enabling a user to visualize a marketing strategy and its effects on a marketplace, the method comprising:
enabling representations of creative aspects of the marketing strategy to be linked together in a selectable manner;
associating representations of the effects of the marketing strategy on the marketplace with the representations of the creative aspects; and
presenting at least a subset of the representations of the creative aspects in a user-interactive, creative-aspects-based structure and the representations of the effects of the marketing strategy in a graphical user interface in a manner enabling the user to interact with the representations of the creative aspects and the representations of the effects to visualize the marketing strategy and its effects on the marketplace.

25. A method as in claim 24 further including:
storing a representation of a creative asset and storing marketing information, the creative asset being a creative aspect of the marketing strategy, and the marketing information representing (i) the marketplace and (ii) trafficking of the creative asset via a marketing channel of the marketplace;
wherein associating the representations of the effects of the marketing strategy on the marketplace with the representations of the creative aspects includes:
storing market effect data reflective of an effect on the marketplace caused by the creative asset; and
associating the marketing information and the market effect data with the representation of the creative asset.

26. A method as in claim 24 further including:
storing a representation of the marketing strategy;
associating a representation of an implementation of the marketing strategy with the representation of the marketing strategy, the implementation of the marketing strategy being a first creative aspect of the marketing strategy;
associating a representation of a creative asset with the representation of the implementation of the marketing strategy, the creative asset being a second creative aspect of the marketing strategy.

27. A method as in claim 26 further including:
providing at least one of the creative assets to a plurality of entities for feedback regarding potential performance of the creative asset; and
obtaining a score for the creative asset based on the scores provided by each entity.

28. A method as in claim 26 further including:
storing marketing information, the marketing information representing (i) the marketplace and (ii) trafficking of the creative asset via a marketing channel of the marketplace; and
wherein associating the representations of the effects of the marketing strategy on the marketplace with the representations of the creative aspects includes:
storing market effect data reflective of a given effect on the marketplace caused by the creative asset; and
associating the marketing information and the market effect data with the representation of the creative asset.

29. A method as in claim 28 further including:
consolidating the representation of the marketing strategy, representation of the implementation of the marketing strategy, representation of the creative asset, marketing information, and market effect data to produce a media software object that stores relationship information among the marketing strategy, implementation of the marketing strategy, creative asset, marketplace, marketing channel, and given effect on the marketplace;
associating the media software object with the representation of the creative asset; and
wherein presenting a user-interactive, creative-aspects-based structure includes employing the relationship information of the media software object in a user-selectable manner.

30. A method as in claim 29 wherein the representations of the creative aspects are linked together in a hierarchical fashion resulting in a node-based hierarchy having a root node, intermediate nodes, and leaf nodes, each node of the node-based hierarchy corresponding to one of the representations of the creative aspects and being directly connected to at least one other node.

31. A method as in claim 30 wherein the root node of the node-based hierarchy represents the marketing strategy, wherein the leaf nodes of the node-based hierarchy represent the creative assets, and wherein each intermediate node represents a particular context in which a respective subset of the creative assets, represented by the child leaf nodes of the intermediate node, is employed.

32. A method as in claim 31 further including:
selecting one of the representations of the creative aspects to be a focus of the marketing strategy visualization, resulting in a selected creative aspect representation; and
wherein presenting the user-interactive, creative-aspects-based structure includes:
presenting a node-based structure that includes at least a subset of the nodes in the node-based hierarchy;
presenting the selected creative aspect representation as a central node of the node-based structure;
presenting adjacent nodes that are directly connected to the central node in the node-based hierarchy in positions apart from the central node; and
presenting representations of links extending from the central node to each of the adjacent nodes.

33. A method as in claim 32 wherein presenting the representations of the effects of the marketing strategy includes presenting a representation of a subset of the effects of the marketing strategy on the marketplace as a function of the selected creative aspect representation.

34. A method as in claim 32 wherein the representations of the creative assets are multimedia representations of the creative assets; and
wherein presenting the user-interactive, creative-aspects-based structure includes presenting each leaf node of the node-based structure in a multimedia format corresponding to the multimedia format of the creative asset represented by the node.

35. A method as in claim 34 wherein presenting each leaf node in a multimedia format includes inserting multimedia controls into the associated representation of a creative asset.

36. A method as in claim 32 further including:
selecting one of the adjacent nodes, resulting in a selected adjacent node, to change focus from the central node to the selected adjacent node; and
wherein presenting the node-based structure includes, upon a change in focus from the central node to the selected adjacent node:
minimizing all other adjacent nodes;
presenting the selected adjacent node as a new central node;
presenting new adjacent nodes that are directly connected to the new central node in the node-based hierarchy in positions apart from the new central node; and
presenting representations of links extending from the new central node to each of the new adjacent nodes.

37. A method as in claim 36 further including:
recording the user's sequence of navigating through the node-based structure; and
presenting, at a later time, a series of views of the node-based structure that represent the user's sequence of navigating through the node-based structure.

38. A method as in claim 32 further including:
selecting a representation of a creative asset corresponding to a node of the presented node-based structure, the representation of the creative asset being associated with a media software object;
temporarily adding the media software object to a memory from which the media software object is accessed to be applied to an environment other than the creative-aspects-based structure; and
presenting via the graphical user interface a representation of the memory including the creative asset associated with the media software object added to the memory.

39. A method as in claim 38 further including:
overlaying a representation of the creative asset associated with the media software object onto an image of a given web page to view a resulting image of a web page that includes the creative asset.

40. A method as in claim 38 further including:
enabling selection of multiple media software objects in the memory; and
comparing the respective market effect data associated with the media software objects.

41. A method as in claim 32 further including:
sorting and filtering the creative assets according to specified criteria and based on the relationship information of the media software objects associated with the creative assets; and
presenting at least a subset of the representations of the creative assets in a dynamic page view interface having a plurality of electronic pages, the electronic pages being dynamically created based on the sorted and filtered creative assets, and each representation of a creative asset being displayed on an electronic page of the dynamic page view interface.

42. A method as in claim 41 wherein presenting at least a subset of the representations includes presenting representations of creative assets associated with nodes in levels of the node-based hierarchy that are at or below the level of the node corresponding to the selected creative aspect representation.

43. A method as in claim 32 further including:
sorting and filtering the creative assets according to specified criteria and based on the relationship information of the media software objects associated with the creative assets; and
presenting at least a subset of the representations of the creative assets in a linear interface, the dynamic linear interface being dynamically created based on the sorted and filtered creative assets.

44. A method as in claim 43 wherein each representation of a creative asset is displayed in a position within the linear interface based on a specified attribute of its respective relationship information and relative to the other creative assets' respective relationship information.

45. A method as in claim 32 further including:
sorting at least a subset of the creative assets according to first and second criteria; and
presenting the creative assets in a two-dimensional grid, the creative assets being distributed along a first edge of the grid based on the first criteria and being distributed along a second edge of the grid based on the second criteria.

46. A method as in claim 45 further including:
determining, from the two-dimensional grid, first and second values of the respective first and second criteria being associated with fewer creative assets than that of other values of the first and second criteria; and
reporting the first and second values as indicating potentially underdeveloped areas of marketing.

47. A computer readable medium having computer readable program codes embodied therein for enabling a user to visualize a marketing strategy and its effects on a marketplace, the computer readable medium program codes including instructions that, when executed by a processor, cause the processor to:
enable representations of creative aspects of the marketing strategy to be linked together in a selectable manner;
associate representations of the effects of the marketing strategy on the marketplace with the representations of the creative aspects; and
present at least a subset of the representations of the creative aspects in a user-interactive, creative-aspects-based structure and the representations of the effects of the marketing strategy in a graphical user interface in a manner enabling the user to interact with the representations of the creative aspects and the representations of the effects to visualize the marketing strategy and its effects on the marketplace.
